(19) United States
(12) Patent Application Publication
(10) Pub. No.: US 2026/0193573 A1
(43) Pub. Date: Jul. 9, 2026

(54) A Composition for Removing Body Grime

(71) Applicant: NOVOZYMES A/S, Bagsvaerd (DK)

(72) Inventors: Lone BAUNSGAARD, Bagsvaerd (DK); Bena-Marie LUE, Bagsvaerd (DK)

(73) Assignee: NOVOZYMES A/S, Bagsvaerd (DK)

(21) Appl. No.: 19/131,929

(22) PCT Filed: Dec. 4, 2023
(86) PCT No.: PCT/EP2023/084121

§ 371 Date: May 21, 2025

(30) Foreign Application Priority Data
Dec. 5, 2022 (EP) 22211285.6

(51) Int. Cl. C11D 3/386

(52) U.S. Cl. CPC C11D 3/38618; C11D 3/38627; C11D 3/38636

(57) ABSTRACT

The present invention relates to compositions for increasing body grime removal from laundry comprising i) a surfactant or surfactant system; ii) peptide; iii) a nuclease; and/or iv) one or more enzyme activities selected from the group of protease, alpha-amylase, endoglucanase, lipase, pectate lyase, and mannanase activity, or a mixture thereof. The invention also relates to methods for cleaning or washing laundry comprising body grime and the use of a composition of the invention for increasing body grime removal from laundry.

### REFERENCE TO A SEQUENCE LISTING

This application contains a Sequence Listing in computer readable form, which is incorporated herein by reference.

### BACKGROUND OF THE INVENTION

### Field of the Invention

The present invention relates to compositions for removal of body grime from laundry during cleaning or washing of laundry. The invention also relates to methods of cleaning or washing laundry comprising body grime and the use of compositions of the invention for removing body grime.

### Description of the Related Art

Taboureau et al 2006 Chem Biol Drug Des (68) p. 48-57 concerns antimicrobial peptides designed to develop alternative treatments against multidrug-resistant microorganisms. The antimicrobial peptides disclosed include MA-Novospirin G10 having the sequence MAKNLRRIIRKGIHIIKKYG.

WO2005/105831 concerns antimicrobial peptides. SEQ ID NO: 93 discloses a peptide having the amino acid sequence KNLRRIIRKGIHIIKKYF.

WO 2022/194668 discloses polypeptides having DNase activity having improved stability in detergent compositions.

### SUMMARY OF THE INVENTION

The present invention concerns removing body grime on clothes during cleaning or washing, in particular laundry cleaning or washing. Stains on laundry are typically protein-based stains like blood and grass, food stains like chocolate and tomato sauce, stains from oils and grease, stains from milk products, and stains from fruits and vegetables. Such stains can often be removed by washing with detergents containing enzymes. Body grime found on clothes comprises a distinct type of substances. Body grime is a complex mixture of sweat, sebum, dead skin cells, and other impurities accumulating on the skin surface as a result of normal bodily functions. The body grime can build up on clothes and cause discoloration or staining on fabrics and can be difficult to remove.

In the first aspect, the present invention relates to a composition comprising:
i) a surfactant or surfactant system; and
ii) a peptide having the sequence KNLRRIIRKGIHIIKKYF (SEQ ID NO: 1) or a peptide having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1,
iii) a nuclease; and/or
iv) one or more enzyme activities selected from the group of protease (EC 3.4.21.62), alpha-amylase (EC 3.2.1.1), endoglucanase (EC 3.2.1.4), lipase (EC 3.1.1.3), pectate lyase (EC 4.2.2.2), and mannanase (EC 3.2.1.78) activity, or a mixture thereof.

In a preferred embodiment, the nuclease has DNase and/RNase activity.

In especially preferred embodiments, the nuclease is one of the DNases shown in any of SEQ ID NOs: 2, 3, 4, 5, 6, 7, 8, 9, 10, 11, 12, 13, 14, 15, 16, 17, 18, 19, 20, 21, or 22, respectively, in particular a DNase shown in SEQ ID NO: 2, SEQ ID NO: 5 or SEQ ID NO: 21, respectively, or a DNase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NOs: 2, 3, 4, 5, 6, 7, 8, 9, 10, 11, 12, 13, 14, 15, 16, 17, 18, 19, 20, 21, or 22, respectively, in particular SEQ ID NOs: 2, 5 or 21, respectively.

A composition of the invention provides increased body grime removal when used in a cleaning or washing process, especially in a process of cleaning or washing laundry comprising body grime, compared to the same composition, when:
no peptide according to SEQ ID NO: 1 is present; and/or
no nuclease, such as the DNases of any of SEQ ID NOs: 2, 3, 4, 5, 6, 7, 8, 9, 10, 11, 12, 13, 14, 15, 16, 17, 18, 19, 20, 21, or 22, respectively, in particular SEQ ID NO: 2, SEQ ID NO: 5 or SEQ ID NO: 21, respectively, is present; and/or
no enzyme activities selected from the group of protease (EC 3.4.21.62), alpha-amylase (EC 3.2.1.1), endoglucanase (EC 3.2.1.4), lipase (EC 3.1.1.3), pectate lyase (EC 4.2.2.2), and mannanase (EC 3.2.1.78) activity, or a mixture thereof, is (are) present.

In a second aspect, the invention relates to methods for cleaning or washing laundry comprising contacting the laundry comprising body grime with a composition of the invention.

In a third aspect, the invention relates to the use of a composition according to the invention for removing body grime from laundry.

### Overview of Sequence Listing

SEQ ID NO: 1 Peptide sequence
SEQ ID NO: 2 DNase polypeptide from Aspergillus oryzae
SEQ ID NO: 3 DNase polypeptide from Aspergillus oryzae with truncated N-terminal
SEQ ID NO: 4 DNase polypeptide from Aspergillus oryzae with truncated N-terminal
SEQ ID NO: 5 DNase variant of the polypeptide of SEQ ID NO: 20 from Bacillus cibi
SEQ ID NO: 6 DNase polypeptide from Metabacillus indicus (formerly Bacillus cibi)
SEQ ID NO: 7 DNase polypeptide, variant of SEQ ID NO: 6
SEQ ID NO: 8 nuclease polypeptide from Trichoderma reesei
SEQ ID NO: 9 nuclease polypeptide from Tolypocladium inflatum
SEQ ID NO: 10 nuclease polypeptide from Blastomyces gilchristii
SEQ ID NO: 11 nuclease polypeptide from Gelasinospora tetrasperma
SEQ ID NO: 12 nuclease polypeptide from Streptococcus dysgalactiae
SEQ ID NO: 13 nuclease polypeptide from Thermobifida cellulosilytica
SEQ ID NO: 14 nuclease polypeptide from Rasamsonia composticola
SEQ ID NO: 15 nuclease polypeptide from Chaetosartorya cremea
SEQ ID NO: 16 nuclease polypeptide from Aspergillus bisporus
SEQ ID NO: 17 nuclease polypeptide from Aspergillus clavatus
SEQ ID NO: 18 nuclease polypeptide from Metarhizium acridum
SEQ ID NO: 19 nuclease polypeptide from Aspergillus ochraceoroseus
SEQ ID NO: 20 DNase polypeptide variant of Bacillus cibi in SEQ ID NO: 22
SEQ ID NO: 21 DNase polypeptide variant of SEQ ID NO: 5
SEQ ID NO: 22 DNase polypeptide from Bacillus cibi.

### Definitions

Body grime: The term “body grime” means a complex mixture of sweat, sebum, dead skin cells, and other impurities accumulating on the skin surface as a result of normal bodily functions.

Fragment: The term “fragment” means a polypeptide having one or more (e.g., several) amino acids absent from the amino and/or carboxyl terminus of a polypeptide; wherein the fragment has enzymatic activity.

Nuclease: Nucleases are enzymes that break down nucleic acids, such as DNA and RNA, into smaller components. There are different types of nucleases, including endonucleases, exonucleases, and ribonucleases. Endonucleases cleave the phosphodiester bonds within a nucleic acid strand, while exonucleases cleave nucleotides from the ends of a nucleic acid molecule. Ribonucleases specifically target RNA molecules. The Enzyme Commission (EC) classifies nucleases under hydrolases, which are enzymes that break down chemical bonds through the addition of water. Specifically, DNases (enzymes that cleave DNA) are classified under EC 3.1.21-29, while RNases (enzymes that cleave RNA) are classified under EC 3.1.13-16. The specific EC number for a particular nuclease enzyme depends on its mechanism of action and substrate specificity. For example, DNase I is classified under EC 3.1.21.1, while RNase A is classified under EC 3.1.27.5).

RNase (ribonuclease): RNases are nucleases having RNase (ribonuclease) activity and catalyzing the cleavage of RNA molecules into smaller fragments. RNases may be classified under EC 3.1.13-16, which is a subcategory of hydrolases. RNases specifically target the phosphodiester bonds that link the nucleotides in the RNA backbone, resulting in the formation of shorter RNA fragments. There are various types of RNases that differ in their substrate specificity, mechanism of action, and biological functions.

DNase (deoxyribonuclease): DNases are nucleases having DNase (deoxyribonuclease) activity and catalyzes the hydrolytic cleavage of phosphodiester linkages in DNA, thus degrading DNA. DNases belong to the esterases (EC number 3.1), a subgroup of the hydrolases. DNases may be classified in several subclasses, in particular EC 3.1.21 and its subclasses. For purposes of the present invention, DNase activity may be determined according to the procedure described in Assay I in the “Materials & Methods” section. The terms “DNase” and “a polypeptide with DNase activity” may be used interchangeably throughout the application.

Proteases: Proteases (EC 3.4.x.x) are enzymes that catalyze the hydrolysis of peptide bonds in proteins, resulting in the cleavage of the protein into smaller peptides and amino acids. Suitable proteases in context of the invention are usually bacterial serine proteases. Serine proteases belongs to a subclass of proteases that use a serine residue in their active site to perform this reaction. The most well-known serine protease is subtilisins (EC 3.4.21.62), which was first isolated from the bacterium Bacillus subtilis. Other subtilisins are derived from Bacillus lentus and Bacillus clauii. Subtilisins have been widely used in various industrial applications, including laundry and dishwashing detergents due to its ability to break down protein-based stains.

Suitable commercial serine proteases include those sold under the trade names Alcalase®, Blaze®; Duralase™, Durazym™, Relase®, Relase® Ultra, Savinase®, Savinase® Ultra, Primase®, Polarzyme®, Kannase®, Liquanase®, Liquanase® Ultra, Progress Uno™ Ovozyme®, Coronase®, Coronase® Ultra, Neutrase®, Everlase® and Esperase® (Novozymes A/S), those sold under the tradename Maxatase®, Maxacal®, Maxapem®, Purafect®, Purafect Prime®, Preferenz™, Purafect MAR, Purafect Ox®, Purafect OxPR, Puramax®, Properase®, Effectenz™, FN2®, FN3R, FN4®, Excellase®, Opticlean®, Optimase®, Preferenz™ P400 (Danisco/DuPont/IFF), Axapem™ (Gist-Brocases N.V.), BLAP (sequence shown in FIG. 29 of U.S. Pat. No. 5,352,604) and variants hereof (Henkel AG) and KAP (Bacillus alkalophilus subtilisin) from Kao.

Alpha-Amylases: Alpha-amylases (EC 3.2.1.1) are enzymes that catalyze the hydrolysis of alpha-1,4-glycosidic bonds in starch and glycogen, resulting in the formation of smaller carbohydrates such as maltose and glucose. Alpha-amylases can help break down and remove starch-based stains, making them easier to remove during cleaning or washing processes. By using alpha-amylase-containing detergents, consumers can achieve better stain removal results, especially with tough-to-remove starch-based stains. Suitable alpha-amylases are usually produced by microorganisms, including especially bacteria such as Bacillus and Cytophaga.

Suitable commercial alpha-amylases are of bacterial origin and include Duramyl™, Termamyl™, Termamyl Ultra™, Stainzyme™, Stainzyme Plus™, Amplify®, Amplify® Prime, Achieve® Choice, Achieve® Advance, Natalase™ (from Novozymes A/S), KEMZYM® AT 9000 Biozym Biotech Trading GmbH Wehlistrasse 27b A-1200 Wien Austria, and Rapidase™, Purastar™/Effectenz™, Powerase, Preferenz S100, Preferenx S110, Preferenz S210, ENZYSIZER, OPTISIZE HT PLUS®, and PURASTAR OXAM® (Danisco/DuPont) and KAM® (Kao).

Lipases: Lipases (EC 3.1.1.3) are enzymes that catalyze the hydrolysis of ester bonds in triglycerides, resulting in the breakdown of fats or oils into glycerol and fatty acids. Lipase used in context of the invention may be of microbial origin, such as of bacterial or fungal origin, preferably of filamentous fungus origin. Examples of especially preferred fungal lipases include lipases from Thermomyces, e.g., from Thermomyces lanuginosus (previously named Humicola lanuginosa) as described in EP258068 and EP305216 and which has the amino acid sequence shown in positions 1-269 of SEQ ID NO: 2 of U.S. Pat. No. 5,869,438 (hereby incorporated by reference), cutinase from Humicola, e.g., H. insolens (WO96/13580), lipase from Absidia reflexa disclosed in US 2009/0221033 A1 (SEQ ID NO: 3), and lipase from Geotrichum candidum (GCL 1) (SEQ ID NO: 1 in WO 2022/162043-hereby incorporated by reference).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500 (all documents hereby incorporated by reference).

Suitable commercial lipases include Lipolase™, Lipex™; Lipolex™, Lipoclean™, Lipex Evity 100L, Lipex Evity 105T, Lipex Evity 200L (Novozymes A/S), Lumafast (originally from Genencor), Preferenz L100 (Danisco US Inc.), and Lipomax (originally from Gist-Brocades).

Endoglucanases: Endoglucanases (EC 3.2.1.4) are enzymes that break down cellulose by cleaving the internal beta-1,4 glycosidic bonds within the cellulose molecule. Suitable endoglucanases in context of the invention include those of bacterial or fungal origin. Chemically modified or protein engineered mutants are contemplated. Suitable endoglucanases include those from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO89/09259. A preferred endoglucanase includes a bacterial polypeptide endogenous to a member of the genus Bacillus which has a sequence of at least 90%, 94%, 97% or 99% identity to the amino acid sequence SEQ ID NO: 2 in U.S. Pat. No. 7,141,403 (hereby incorporated by reference).

Especially suitable endoglucanases are alkaline or neutrale. Examples of suitable commercial products which comprise endoglucanase activity include Carezyme™ Premium, Carezyme™ Core, Celluclean™, Whitezyme®, Renozyme™, Denimax™, Cellusoft Ultra™, and Luminous™ (Novozymes A/S), Clazinase™ and Puradax HA™ (Danisco US Inc.), and KAC-500 (B)™ (Kao Corporation).

Pectate lyases: Pectate lyases (EC 4.2.2.2) are enzymes that catalyze the cleavage of glycosidic bonds in pectin, a complex polysaccharide found in the cell walls of plants. Specifically, pectate lyases cleave the α-1,4-glycosidic bonds between galacturonic acid residues in pectin, resulting in the formation of unsaturated oligogalacturonides and water-soluble fragments. Pectate lyases are produced by a variety of microorganisms, including bacteria, fungi, and yeasts, as well as some plant tissues.

Suitable commercial pectate lyase products include Pectawash®, Pectaway®, and Xpect® (Novozymes A/S).

Mannanases: Mannanases (EC 3.2.1.78) are enzyme that catalyze the hydrolysis of mannan, a complex polysaccharide found in many plant cell walls and hemicelluloses. In laundry detergents, mannanases are used to improve the cleaning performance on plant-based stains, such as those from fruits, vegetables, and legumes. Mannanases are produced by a variety of microorganisms, including bacteria, fungi, and yeasts.

Suitable commercial mannanase products for detergents include: Mannaway® (Novozymes), Purabrite® and Preferenz M200 (Danisco/DuPont/IFF), and Lavergy M ACE 100L (BASF).

Parent or parent enzyme: The term “parent” or “parent enzyme” means an enzyme to which an alteration is made to produce the enzyme variants. The parent may be a naturally occurring (wild-type) polypeptide but may also be a variant and/or fragment thereof.

Peptide: The term “peptide” means an organic chemical molecule that contains two or more amino acids joined together by peptide bonds. In context of the present invention, the peptide shown in SEQ ID NO: 1 increases body grime removing performance/activity of enzymes during cleaning or washing.

In an embodiment, the peptide used according to the invention, does not (when used alone) have enzymatic activity.

Sequence identity: The relatedness between two amino acid sequences is described by the parameter “sequence identity”.

For purposes of the present invention, the sequence identity between two amino acid sequences is determined using the Needleman-Wunsch algorithm (Needleman and Wunsch, 1970, J. Mol. Biol. 48:443-453) as implemented in the Needle program of the EMBOSS package (EMBOSS: The European Molecular Biology Open Software Suite, Rice et al., 2000, Trends Genet. 16:276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

Laundry: The term “laundry” includes according to the invention textiles, clothes, linen and the like and may be made from any material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the terms fabric or garment are used, it is intended to include the broader term textiles as well. In the context of the present invention, the term “laundry” also covers fabrics.

Wild-type Enzyme: The term “wild-type” enzyme means an enzyme expressed by a naturally occurring microorganism, such as a bacterium, yeast, or filamentous fungus found in nature.

Variant: The term “variant” means a polypeptide having the desired activity (e.g., desired enzymatic activity, such as, e.g., lipase activity) comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position.

Wash Performance: Wash performance may be tested using any suitable assay measuring the body grime removal performance/activity. See the Examples.

Sequence identity: The relatedness between two amino acid sequences is described by the parameter “sequence identity”. For purposes of the present invention, the sequence identity between two amino acid sequences is determined as the output of “longest identity” using the Needleman-Wunsch algorithm (Needleman and Wunsch, 1970, J. Mol. Biol. 48:443-453) as implemented in the Needle program of the EMBOSS package (EMBOSS: The European Molecular Biology Open Software Suite, Rice et al., 2000, Trends Genet. 16:276-277), preferably version 6.6.0 or later.

The parameters used are a gap open penalty of 10, a gap extension penalty of 0.5, and the EBLOSUM62 (EMBOSS version of BLOSUM62) substitution matrix. In order for the Needle program to report the longest identity, the—nobrief option must be specified in the command line. The output of Needle labeled “longest identity” is calculated as follows:

(Identical Residues×100)/(Length of Alignment−Total Number of Gaps in Alignment)

Designation of Variants: In describing variants, the nomenclature described below is adapted for ease of reference. The accepted IUPAC single letter or three letter amino acid abbreviation is employed.

Substitutions. For an amino acid substitution, the following nomenclature is used: Original amino acid, position, substituted amino acid. Accordingly, the substitution of threonine at position 226 with alanine is designated as “Thr226Ala” or “T226A”. Multiple mutations are separated by addition marks (“+”), e.g., “Gly205Arg+Ser411Phe” or “G205R+S411F”, representing substitutions at positions 205 and 411 of glycine (G) with arginine (R) and serine(S) with phenylalanine (F), respectively.

Deletions. For an amino acid deletion, the following nomenclature is used: Original amino acid, position, *. Accordingly, the deletion of glycine at position 195 is designated as “Gly195*” or “G195*”. Multiple deletions are separated by addition marks (“+”), e.g., “Gly195*+Ser411*” or “G195*+S411*”.

Insertions. For an amino acid insertion, the following nomenclature is used: Original amino acid, position, original amino acid, inserted amino acid. Accordingly, the insertion of lysine after glycine at position 195 is designated “Gly195GlyLys” or “G195GK”. An insertion of multiple amino acids is designated [Original amino acid, position, original amino acid, inserted amino acid #1, inserted amino acid #2; etc.]. For example, the insertion of lysine and alanine after glycine at position 195 is indicated as “Gly195GlyLysAla” or “G195GKA”.

In such cases the inserted amino acid residue(s) are numbered by the addition of lower case letters to the position number of the amino acid residue preceding the inserted amino acid residue(s). In the above example, the sequence would thus be:

| Parent: | Variant: |
|---|---|
| 195 | 195 195a 195b |
| G | G - K - A |

Multiple alterations. Variants comprising multiple alterations are separated by addition marks (“+”), e.g., “Arg170Tyr+Gly195Glu” or “R170Y+G195E” representing a substitution of arginine and glycine at positions 170 and 195 with tyrosine and glutamic acid, respectively.

Different alterations. Where different alterations can be introduced at a position, the different alterations are separated by a comma, e.g., “Arg170Tyr, Glu” or “R170Y, E” represents a substitution of arginine at position 170 with tyrosine or glutamic acid. Thus, “Tyr167Gly, Ala+Arg170Gly, Ala” designates the following variants:
“Tyr167Gly+Arg170Gly”, “Tyr167Ala+Arg170Ala”, “Tyr167Ala+Arg170Gly”, and “Tyr167Gly+Arg170Ala”.

### DETAILED DESCRIPTION OF THE INVENTION

The present invention concerns removing body grime from laundry during cleaning or washing.

### Compositions of the Invention

In the first aspect, the present invention relates to a composition comprising:
i) a surfactant or surfactant system; and
ii) peptide having the sequence KNLRRIIRKGIHIIKKYF (SEQ ID NO: 1) or a peptide having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1,
iii) a nuclease; and/or
iv) one or more enzyme activities selected from the group of protease (EC 3.4.21.62), alpha-amylase (EC 3.2.1.1), endoglucanase (EC 3.2.1.4), lipase (EC 3.1.1.3), pectate lyase (EC 4.2.2.2), and mannanase (EC 3.2.1.78) activity, or a mixture thereof.

Peptides suitable for use in a composition of the invention have the sequence KNLRR IIRKG IHIIK KYF (SEQ ID NO: 1) or a sequence having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1.

The above-mentioned peptides are capable of increasing body grime removal on clothes during cleaning or washing when used together with i) a nuclease, in particular a DNase, and/or ii) one or more enzyme activities selected from the group of protease activity, alpha-amylase activity, endoglucanase activity, lipase activity, pectate lyase activity, and mannanase activity, or a mixture thereof.

In a preferred embodiment, a composition of the invention comprises:
a peptide as defined above; in particular SEQ ID NO: 1 or a sequence having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1; and
a nuclease, in particular any one of the DNases shown in any one of SEQ ID NOs: 2, 3, 4, 5, 6, 7, 8, 9, 10, 11, 12, 13, 14, 15, 16, 17, 18, 19, 20, 21, or 22, respectively, in particular a DNase shown in any of SEQ ID NOs: 2, 5 or 21, respectively.

In another preferred embodiment, a composition of the invention comprises:
a peptide as defined above; in particular SEQ ID NO: 1 or a sequence having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1; and
one or more, in particular all, enzyme activities selected from the group of protease, alpha-amylase, endoglucanase, lipase, pectate lyase, and mannanase activity.

Without being limited to any theory, it is believed that the peptide enhances the enzymatic activity of one or more of the enzymes, while at the same time, the composition comprises enzymatic activities capable of degrading body grime components.

In an embodiment, the peptide does not have enzymatic activity, in particular does not have protease, alpha-amylase, endoglucanase, lipase, pectate lyase, or mannanase activity.

A peptide used in context of the invention may be alkaline.

In an embodiment, the peptide has a high K (Lys) and/or R (Arg) content.

In a preferred embodiment, the peptide defined above comprise or consist of 18 amino acids.

In an embodiment, the peptides of the invention defined above have a high K (Lys) and/or R (Arg) content.

In an embodiment, the peptide has a K (Lys) in positions corresponding to position 1 and/or position 9 and/or position 15 and/or position 16 using SEQ ID NO: 1 for numbering.

In an embodiment, the peptide defined above have a R (Arg) in positions corresponding to position 4 and/or position 5 and/or position 8.

In an embodiment, the peptide has at least 4 K, such as 5 K, such as 6 K, such as 7 K.

In an embodiment, the peptides defined above have at least 3 R, such as 4 R, such as 5 R, such as 6 R, or such as 8 R.

In an embodiment, the peptides defined above have at least 15% R (Arg), such as at least 20% R (Arg), in particular at least 25% R (Arg).

In an embodiment, the peptides defined above have at least 20% K (Lys), such as at least 25% K (Lys), in particular at least 3 K (Lys).

In an embodiment, the peptide consists of 13-23 amino acids, such as 15-21 amino acids, such as 13 amino acids, such as 14 amino acids, such as 15 amino acids, such as 17 amino acids, in particular 17 amino acids, such as 18 amino acids, such as 19 amino acids, such as 20 amino acids, such as at least 21 amino acids, such as 22 amino acids, such as at least 23 amino acids. In an especially preferred embodiment, the peptides defined above comprise or consist of 18 amino acids.

In an embodiment, the nuclease has DNase and/or RNase activity.

In a preferred embodiment, the nuclease is a DNase selected from the group of polypeptides of any one of: SEQ ID NOs: 2, 3, 4, 5, 6, 7, 8, 9, 10, 11, 12, 13, 14, 15, 16, 17, 18, 19, 20, 21, or 22 or a DNase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 2, 3, 4, 5, 6, 7, 8, 9, 10, 11, 12, 13, 14, 15, 16, 17, 18, 19, 20, 21, or 22, respectively.

In a preferred embodiment, the composition comprises a nuclease selected from the group of DNases in any one SEQ ID NO: 2, SEQ ID NO: 5 and SEQ ID NO: 21, respectively, or a DNase having at least 60%, at least 65%, at least 70%, at least 75%, at least 80%, at least 85%, at least 90%, at least 95% identity, at least 96%, at least 97%, at least 98%, or at least 99%, or 100% sequence identity to any one of SEQ ID NO: 2, SEQ ID NO: 5 and SEQ ID NO: 21, respectively.

In a preferred embodiment, the nuclease comprised in a composition of the invention is a DNase variant which compared to the polypeptide of SEQ ID NO: 5 further comprising two or more substitutions corresponding to the substitutions from the group consisting of N61D, T651, T65V, S82R, K107Q, T127S, T127V, G149N, S164D and L181S, wherein the variant has at least 60%, at leasts 70%, at least 80%, at least 85%, at least 90%, at least 95%, at least 96%, at least 97%, at least 98%, at least 99% sequence, but less than 100% identity to SEQ ID NO: 5, and has DNase activity.

In an embodiment, nuclease, preferably DNase, comprises two, three, four, five substitutions.

In an embodiment, the DNase further comprises at least one substitution corresponding to a substitution selected from the group consisting of Q14R, Q14W, K21L, P25S, L33K, Q48D, D561, D56L, S66Y, S68L, Y77T, S102Y, S106A, R109Q, R109T, D116S, D116W, T171W, L181T and L181W (using SEQ ID NO: 5 for numbering).

In an embodiment, the nuclease is a DNase variant comprising a set of substitutions corresponding to the substitutions selected from the group consisting of:
a) G149N together with at least one of the substitutions N61D, T651, T65V, S82R, K107Q, T127S, T127V, S164D and L181S;
b) T651 or T65V together with at least two of the substitutions N61D, S82R, K107Q, T127S, T127V, G149N, S164D and L181S;
c) N61D together with at least two of the substitutions T65I/V, S82R, K107Q, T127S/V, G149N, S164D and L181S, preferably at least two of the substitutions T65I/V, S82R, K107Q, T127S and S164D;
d) S82R together with at least two of the substitutions N61D, T651, T65V, K107Q, T127S, T127V, G149N, S164D and L181S;
e) K107Q together with at least two of the substitutions N61D, T65I, T65V, S82R, T127S, T127V, G149N, S164D and L181S;
f) T127S together with at least two of the substitutions N61D, T65I, T65V, S82R, K107Q, G149N, S164D and L181S; and
g) S164D together with at least one of the substitutions N61D, T651, T65V, S82R, K107Q, T127S, T127V, G149N and L181S (using SEQ ID NO: 5 for numbering).

In an embodiment, the nuclease is a DNase variant which compared to the polypeptide in SEQ ID NO: 5 comprises substitutions corresponding to one or more, especially both, of the following substitutions: T65V, G149N.

In an embodiment, the nuclease is a DNase variant which compared to the polypeptide in SEQ ID NO: 22 comprises one or more substitutions corresponding to the following substitutions: T11, S13Y, T22P, S25P S27L, S39P, S42G, S57W, S59V, V76L, T77Y, Q109R, S116D, S144P, A147H, S167L, G175D and S181L, in particular all of the substitutions.

According to the invention, a composition of the invention provides increased body grime removal when used in a cleaning or washing process, especially in a process of cleaning or washing laundry comprising body grime, compared to the same composition where:
no peptide as defined above, in particular SEQ ID NO: 1, is present; and/or
no nuclease, in particular a DNase shown in any one of SEQ ID NOs: 2, 3, 4, 5, 6, 7, 8, 9, 10, 11, 12, 13, 14, 15, 16, 17, 18, 19, 20, 21, or 22, respectively, in particular SEQ ID NO: 2, SEQ ID NO: 5 or SEQ ID NO: 21, respectively, is present; and/or
no enzyme activities selected from the group of protease (EC 3.4.21.62), alpha-amylase (EC 3.2.1.1), endoglucanase (EC 3.2.1.4), lipase (EC 3.1.1.3), pectate lyase (EC 4.2.2.2), and mannanase (EC 3.2.1.78) activity, or a mixture thereof, is (are) present.

In an embodiment, the composition comprises a protease, in particular a serine protease, such as a subtilisin, especially a subtilisin derived from Bacillus lentus or Bacillus clausii.

In an embodiment, the alpha-amylase is a bacterial alpha-amylase, such as one derived from Bacillus or Cytophaga.

In an embodiment, the composition comprises an endoglucanase, in particular a Cel45 and/or Cel5A endoglucanase, in particular derived from Thielavia terrestis or Humicola insolens.

In an embodiment, the composition comprises a lipase, in particular a Thermomyces lanuginosus lipase (TLL) or Geotrichum candidum lipase 1 (GCL1).

In an embodiment, the composition comprises a pectate lyase, in particular a Bacillus subtilis pectate lyase.

In an embodiment, the composition comprises a mannanase, in particular an alkalophilic Bacillus mannanase.

In an embodiment, the composition comprises one or more, in particular all, of the following enzyme activities: protease (EC 3.4.21.62), alpha-amylase (EC 3.2.1.1), endoglucanase (EC 3.2.1.4), lipase (EC 3.1.1.3), pectate lyase (EC 4.2.2.2), and mannanase (EC 3.2.1.78) activity.

### Surfactant or Surfactant System

A composition of the present invention comprises a surfactant or surfactant system.

In an embodiment, the surfactant or surfactant system comprises one or more surfactants selected from: nonionic surfactants, anionic surfactants, cationic surfactants, ampholytic surfactants, zwitterionic surfactants, semi-polar nonionic surfactants, and mixtures thereof.

The surfactant(s) is (are), in preferred embodiments present at a level of from 0.1 to 60 wt %, from 0.2 to 40 wt %, from 0.5 to 30 wt %, from 1 to 50 wt %, from 1 to 40 wt %, from 1 to 30 wt %, from 1 to 20 wt %, from 3 to 10 wt %, from 3 to 5 wt %, from 5 to 40 wt %, from 5 to 30 wt %, from 5 to 15 wt %, from 3 to 20 wt %, from 3 to 10 wt %, from 8 to 12 wt %, from 10 to 12 wt %, from 20 to 25 wt % or from 25-60%.

Suitable anionic detersive surfactants include sulphate and sulphonate detersive surfactants.

Suitable sulphonate detersive surfactants include alkyl benzene sulphonate, in one aspect, C₁₀₋₁₃ alkyl benzene sulphonate. Suitable alkyl benzene sulphonate (LAS) may be obtained, by sulphonating commercially available linear alkyl benzene (LAB); suitable LAB includes low 2-phenyl LAB, such as Isochem® or Petrelab®, other suitable LAB include high 2-phenyl LAB, such as Hyblene®. A suitable anionic detersive surfactant is alkyl benzene sulphonate that is obtained by DETAL catalyzed process, although other synthesis routes, such as HF, may also be suitable. In one aspect a magnesium salt of LAS is used.

Suitable sulphate detersive surfactants include alkyl sulphate, in one aspect, C₈₋₁₈ alkyl sulphate, or predominantly C₁₂ alkyl sulphate.

Another suitable sulphate detersive surfactant is alkyl alkoxylated sulphate, in one aspect, alkyl ethoxylated sulphate, in one aspect, a C₈₋₁₈ alkyl alkoxylated sulphate, in another aspect, a C₈₋₁₈ alkyl ethoxylated sulphate, typically the alkyl alkoxylated sulphate has an average degree of alkoxylation of from 0.5 to 20, or from 0.5 to 10, typically the alkyl alkoxylated sulphate is a C₈₋₁₈ alkyl ethoxylated sulphate having an average degree of ethoxylation of from 0.5 to 10, from 0.5 to 7, from 0.5 to 5 or from 0.5 to 3.

The alkyl sulphate, alkyl alkoxylated sulphate and alkyl benzene sulphonates may be linear or branched, substituted or un-substituted.

The detersive surfactant may be a mid-chain branched detersive surfactant, in one aspect, a mid-chain branched anionic detersive surfactant, in one aspect, a mid-chain branched alkyl sulphate and/or a mid-chain branched alkyl benzene sulphonate, e.g. a mid-chain branched alkyl sulphate. In one aspect, the mid-chain branches are C₁₋₄ alkyl groups, typically methyl and/or ethyl groups.

Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS) or sodium lauryl sulfate (SLS), fatty alcohol sulfates (FAS), primary alcohol sulfates (PAS), alcohol ethersulfates (AES or AEOS or FES, also known as alcohol ethoxysulfates or fatty alcohol ether sulfates), sodium laureth sulfate (SLES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

Suitable non-ionic detersive surfactants are selected from the group consisting of: C₈-C₁₈ alkyl ethoxylates, such as, NEODOL®; C₆-C₁₂ alkyl phenol alkoxylates wherein the alkoxylate units may be ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic®; C₁₄-C₂₂ mid-chain branched alcohols; C₁₄-C₂₂ mid-chain branched alkyl alkoxylates, typically having an average degree of alkoxylation of from 1 to 30; alkylpolysaccharides, in one aspect, alkylpolyglycosides; polyhydroxy fatty acid amides; ether capped poly(oxyalkylated) alcohol surfactants; and mixtures thereof.

Suitable non-ionic detersive surfactants include alkyl polyglucoside and/or an alkyl alkoxylated alcohol.

In one aspect, non-ionic detersive surfactants include alkyl alkoxylated alcohols, in one aspect C₈₋₁₈ alkyl alkoxylated alcohol, e.g., a C₈₋₁₈ alkyl ethoxylated alcohol, the alkyl alkoxylated alcohol may have an average degree of alkoxylation of from 1 to 50, from 1 to 30, from 1 to 20, or from 1 to 10. In one aspect, the alkyl alkoxylated alcohol may be a C₈₋₁₈ alkyl ethoxylated alcohol having an average degree of ethoxylation of from 1 to 10, from 1 to 7, more from 1 to 5 or from 3 to 7. The alkyl alkoxylated alcohol can be linear or branched and substituted or un-substituted. Suitable nonionic surfactants include Lutensol®.

Non-limiting examples of nonionic surfactants include alcohol ethoxylates (AE or AEO), such as linear alcohol (C12-15) ethoxylate (LAE), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

Suitable cationic detersive surfactants include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula: (R)(R₁)(R₂)(R₃)N⁺X⁻, wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, e.g. chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

Suitable amphoteric/zwitterionic surfactants include amine oxides and betaines such as alkyldimethylbetaines, sulfobetaines, or combinations thereof. Amine-neutralized anionic surfactants-Anionic surfactants and adjunct anionic cosurfactants, may exist in an acid form, and said acid form may be neutralized to form a surfactant salt which is desirable for use in the present detergent compositions. Typical agents for neutralization include the metal counterion base such as hydroxides, eg, NaOH or KOH. Further preferred agents for neutralizing anionic surfactants of the present invention and adjunct anionic surfactants or cosurfactants in their acid forms include ammonia, amines, or alkanolamines. Alkanolamines are preferred. Suitable non-limiting examples including monoethanolamine, diethanolamine, triethanolamine, and other linear or branched alkanolamines known in the art, e.g., highly preferred alkanolamines include 2-amino-1-propanol, 1-aminopropanol, monoisopropanolamine, or 1-amino-3-propanol. Amine neutralization may be done to a full or partial extent, e.g., part of the anionic surfactant mix may be neutralized with sodium or potassium and part of the anionic surfactant mix may be neutralized with amines or alkanolamines.

Non-limiting examples of semipolar surfactants include amine oxides (AO) such as alkyldimethylamineoxide.

Surfactant systems comprising mixtures of one or more anionic and in addition one or more nonionic surfactants optionally with an additional surfactant such as a cationic surfactant, may be preferred. Preferred weight ratios of anionic to nonionic surfactant are at least 2:1, or at least 1:1 to 1:10.

In one aspect, a surfactant system may comprise a mixture of isoprenoid surfactants represented by formula A and formula B:

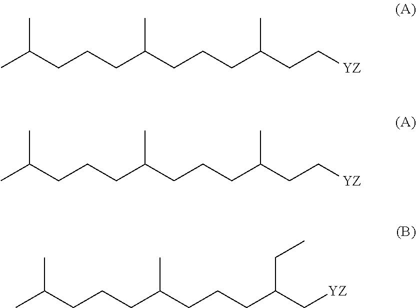

where Y is CH₂ or null, and Z may be chosen such that the resulting surfactant is selected from the following surfactants: an alkyl carboxylate surfactant, an alkyl polyalkoxy surfactant, an alkyl anionic polyalkoxy sulfate surfactant, an alkyl glycerol ester sulfonate surfactant, an alkyl dimethyl amine oxide surfactant, an alkyl polyhydroxy based surfactant, an alkyl phosphate ester surfactant, an alkyl glycerol sulfonate surfactant, an alkyl polygluconate surfactant, an alkyl polyphosphate ester surfactant, an alkyl phosphonate surfactant, an alkyl polyglycoside surfactant, an alkyl monoglycoside surfactant, an alkyl diglycoside surfactant, an alkyl sulfosuccinate surfactant, an alkyl disulfate surfactant, an alkyl disulfonate surfactant, an alkyl sulfosuccinamate surfactant, an alkyl glucamide surfactant, an alkyl taurinate surfactant, an alkyl sarcosinate surfactant, an alkyl glycinate surfactant, an alkyl isethionate surfactant, an alkyl dialkanolamide surfactant, an alkyl monoalkanolamide surfactant, an alkyl monoalkanolamide sulfate surfactant, an alkyl diglycolamide surfactant, an alkyl diglycolamide sulfate surfactant, an alkyl glycerol ester surfactant, an alkyl glycerol ester sulfate surfactant, an alkyl glycerol ether surfactant, an alkyl glycerol ether sulfate surfactant, alkyl methyl ester sulfonate surfactant, an alkyl polyglycerol ether surfactant, an alkyl polyglycerol ether sulfate surfactant, an alkyl sorbitan ester surfactant, an alkyl ammonioalkanesulfonate surfactant, an alkyl amidopropyl betaine surfactant, an alkyl allylated quat based surfactant, an alkyl monohydroxyalkyl-di-alkylated quat based surfactant, an alkyl di-hydroxyalkyl monoalkyl quat based surfactant, an alkylated quat surfactant, an alkyl trimethylammonium quat surfactant, an alkyl polyhydroxalkyl oxypropyl quat based surfactant, an alkyl glycerol ester quat surfactant, an alkyl glycol amine quat surfactant, an alkyl monomethyl dihydroxyethyl quaternary ammonium surfactant, an alkyl dimethyl monohydroxyethyl quaternary ammonium surfactant, an alkyl trimethylammonium surfactant, an alkyl imidazoline-based surfactant, an alken-2-yl-succinate surfactant, an alkyl a-sulfonated carboxylic acid surfactant, an alkyl a-sulfonated carboxylic acid alkyl ester surfactant, an alpha olefin sulfonate surfactant, an alkyl phenol ethoxylate surfactant, an alkyl benzenesulfonate surfactant, an alkyl sulfobetaine surfactant, an alkyl hydroxysulfobetaine surfactant, an alkyl ammoniocarboxylate betaine surfactant, an alkyl sucrose ester surfactant, an alkyl alkanolamide surfactant, an alkyl di(polyoxyethylene) monoalkyl ammonium surfactant, an alkyl mono(polyoxyethylene) dialkyl ammonium surfactant, an alkyl benzyl dimethylammonium surfactant, an alkyl aminopropionate surfactant, an alkyl amidopropyl dimethylamine surfactant, or a mixture thereof; and if Z is a charged moiety, Z is charge-balanced by a suitable metal or organic counter ion. Suitable counter ions include a metal counter ion, an amine, or an alkanolamine, e.g., C₁-C₆ alkanolammonium. More specifically, suitable counter ions include Na+, Ca+, Li+, K+, Mg+, e.g., monoethanolamine (MEA), diethanolamine (DEA), triethanolamine (TEA), 2-amino-I-propanol, 1-aminopropanol, methyldiethanolamine, dimethylethanolamine, monoisopropanolamine, triisopropanolamine, I-amino-3-propanol, or mixtures thereof. In one embodiment, the compositions contain from 5% to 97% of one or more non-isoprenoid surfactants; and one or more adjunct cleaning additives; wherein the weight ratio of surfactant of formula A to surfactant of formula B is from 50:50 to 95:5.

In a preferred embodiment, the composition of the invention comprises one or more anionic surfactant and/or one or more nonionic surfactant.

In an embodiment, the composition comprises one or more anionic surfactants, preferably linear alkylbenzenesulfonic acid (LAS), alcohol ether sulfate (AEOS) and/or alkyl sulfate (AS), in particular sodium lauryl sulfate (SLS) and/or sodium laureth sulfate (SLES).

In an embodiment, the composition comprises one or more non-ionic surfactants, preferably alcohol ethoxylate (AEO), in particular linear alcohol (C12-15) ethoxylate.

In an embodiment, the composition comprises one or more anionic surfactants and one or more nonionic surfactants.

In an embodiment, the composition comprises an anionic surfactant linear alkylbenzenesulfonic acid (LAS) and a nonionic surfactant alcohol ethoxylate (AEO).

In an embodiment, the surfactant system comprises LAS, SLES, and AEO.

In an embodiment, the surfactant system comprises LAS, SLES, AS, and AEO.

In an embodiment the ratio between anionic surfactant and non-ionic surfactant is in the range 20:1 to 1:1, such as 15:1 to 10:1, in particular around 4:1.

In a specific embodiment the surfactant system is Model Detergent 1 described in the Materials & Methods″-section.

A non-limiting list of composition components illustrated hereinafter are suitable for use in the compositions and methods of the invention and may be desirably incorporated in certain embodiments of the invention, e.g., to assist or boost/enhance fat removal and cleaning performance, for treatment of the substrate to be cleaned, or to modify the aesthetics of the composition as is the case with perfumes, colorants, dyes or the like. The levels of any such components incorporated in any compositions are in addition to any materials previously recited for incorporation. The precise nature of these additional components, and levels of incorporation thereof, will depend on the physical form of the composition and the nature of the cleaning operation for which it is to be used. Although components mentioned below are categorized by general header according to a particular functionality, this is not to be construed as a limitation, as a component may comprise additional functionalities as will be appreciated by the skilled artisan.

Unless otherwise indicated, amounts in percentage are by weight of the composition (wt %). Suitable component materials include, but are not limited to, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, perfume delivery systems, structure elasticizing agents, fabric softeners, carriers, hydrotropes, processing aids, solvents and/or pigments. In addition to the disclosure below, suitable examples of such other components and levels of use are found in U.S. Pat. Nos. 5,576,282, 6,306,812, and 6,326,348 hereby incorporated by reference.

Thus, in certain embodiments, compositions of the invention do not contain one or more of the following adjuncts materials: surfactants, soaps, builders, chelating agents, dye transfer inhibiting agents, dispersants, additional enzymes, enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, perfume delivery systems, structure elasticizing agents, fabric softeners, carriers, hydrotropes, processing aids, solvents and/or pigments. However, when one or more components are present, such one or more components may be present as detailed below:

### Soap

The compositions of the invention may also contain soap. Without being limited by theory, it may be desirable to include soap as it acts in part as a surfactant and in part as a builder and may be useful for suppression of foam and may furthermore interact favorably with the various cationic compounds of the composition to enhance softness on textile fabrics treaded with the inventive compositions. Any soap known in the art for use in laundry detergents may be utilized. In one embodiment, the compositions contain from 0 wt % to 20 wt %, from 0.5 wt % to 20 wt %, from 4 wt % to 10 wt %, or from 4 wt % to 7 wt % of soap.

Examples of soap useful herein include oleic acid soaps, palmitic acid soaps, palm kernel fatty acid soaps, and mixtures thereof. Typical soaps are in the form of mixtures of fatty acid soaps having different chain lengths and degrees of substitution. One such mixture is topped palm kernel fatty acid.

In one embodiment, the soap is selected from free fatty acid. In a preferred embodiment the composition comprises coco fatty acid. Other suitable fatty acids are saturated and/or unsaturated and can be obtained from natural sources such a plant or animal esters (e.g., palm kernel oil, palm oil, coconut oil, babassu oil, safflower oil, tall oil, castor oil, tallow and fish oils, grease, and mixtures thereof), or synthetically prepared (e.g., via the oxidation of petroleum or by hydrogenation of carbon monoxide via the Fisher Tropsch process).

Examples of suitable saturated fatty acids for use in the compositions of this invention include captic, lauric, myristic, palmitic, stearic, arachidic and behenic acid. Suitable unsaturated fatty acid species include: palmitoleic, oleic, linoleic, linolenic and ricinoleic acid. Examples of preferred fatty acids are saturated Cn fatty acid, saturated Ci₂-Ci₄ fatty acids, and saturated or unsaturated Cn to Ci₈ fatty acids, and mixtures thereof.

When present, the weight ratio of fabric softening cationic cosurfactant to fatty acid is preferably from about 1:3 to about 3:1, more preferably from about 1:1.5 to about 1.5:1, most preferably about 1:1.

Levels of soap and of nonsoap anionic surfactants herein are percentages by weight of the detergent composition, specified on an acid form basis. However, as is commonly understood in the art, anionic surfactants and soaps are in practice neutralized using sodium, potassium or alkanolammonium bases, such as sodium hydroxide or monoethanolamine.

### Hydrotropes

A composition of the present invention may also comprise one or more hydrotropes. A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however, the molecular structure of hydrotropes generally do not favor spontaneous self-aggregation, see, e.g., review by Hodgdon and Kaler (2007), Current Opinion in Colloid & Interface Science 12:121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent composition of the invention may contain from 0 to 10 wt %, such as from 0 to 5 wt %, 0.5 to 5 wt %, or from 3% to 5 wt %, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders

A composition of the present invention may also comprise one or more builders, co-builders, builder systems or a mixture thereof. When a builder is used, the cleaning composition will typically comprise from 0 to 65 wt %, at least 1 wt %, from 2 to 60 wt % or from 5 to 10 wt % builder. In a dish wash cleaning composition, the level of builder is typically 40 to 65 wt % or 50 to 65 wt %. The composition may be substantially free of builder; substantially free means “no deliberately added” zeolite and/or phosphate. Typical zeolite builders include zeolite A, zeolite P and zeolite MAP. A typical phosphate builder is sodium tri-polyphosphate.

The builder and/or co-builder may particularly be a chelating agent that forms water-soluble complexes with Ca and Mg. Any builder and/or co-builder known in the art for use in detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan −1-ol (MEA), iminodiethanol (DEA) and 2,2′,2″-nitrilotriethanol (TEA), and carboxymethylinulin (CMI), and combinations thereof.

The composition may include a co-builder alone, or in combination with a builder, e.g. a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), etheylenediaminetetraacetic acid (EDTA), diethylenetriaminepentaacetic acid (DTPA), iminodisuccinic acid (IDS), ethylenediamine-N, N′-disuccinic acid (EDDS), methylglycinediacetic acid (MGDA), glutamic acid-N,N-diacetic acid (GLDA), 1-hydroxyethane-1,1-diylbis(phosphonic acid) (HEDP), ethylenediaminetetrakis(methylene)tetrakis(phosphonic acid) (EDTMPA), diethylenetriaminepentakis(methylene)pentakis (phosphonic acid) (DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N, N-diacetic acid (SLDA), taurine-N, N-diacetic acid (TUDA) and sulfomethyl-N,N-diacetic acid (SMDA), N-(hydroxyethyl)-ethylidenediaminetriacetate (HEDTA), diethanolglycine (DEG), Diethylenetriamine Penta (Methylene Phosphonic acid) (DTPMP), aminotris(methylenephosphonic acid) (ATMP), and combinations and salts thereof. Further exemplary builders and/or co-builders are described in, e.g., WO09/102854, U.S. Pat. No. 5,977,053.

### Chelating Agents and Crystal Growth Inhibitors

A composition of the invention may also comprise a chelating agent and/or a crystal growth inhibitor. Suitable molecules include copper, iron and/or manganese chelating agents and mixtures thereof. Suitable molecules include DTPA (Diethylene triamine pentaacetic acid), HEDP (Hydroxyethane diphosphonic acid), DTPMP (Diethylene triamine penta(methylene phosphonic acid)), 1,2-Dihydroxybenzene-3,5-disulfonic acid disodium salt hydrate, ethylenediamine, diethylene triamine, ethylenediaminedisuccinic acid (EDDS), N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP), carboxymethyl inulin and 2-Phosphonobutane 1,2,4-tricarboxylic acid (Bayhibit® AM) and derivatives thereof. Typically, the composition may comprise from 0.005 to 15 wt % or from 3.0 to 10 wt % chelating agent or crystal growth inhibitor.

### Bleach Components

A composition of the invention may also comprise a bleach component. The bleach component suitable for incorporation in compositions of the invention or use in methods of the invention comprises one or a mixture of more than one bleach component. Suitable bleach components include bleaching catalysts, photobleaches, bleach activators, hydrogen peroxide, sources of hydrogen peroxide, pre-formed peracids and mixtures thereof. In general, when a bleach component is used, the compositions of the present invention may comprise from 0 to 30 wt %, from 0.00001 to 90 wt %, 0.0001 to 50 wt %, from 0.001 to 25 wt % or from 1 to 20 wt %. Examples of suitable bleach components include:

(1) Pre-formed peracids: Suitable preformed peracids include, but are not limited to, compounds selected from the group consisting of pre-formed peroxyacids or salts thereof, typically either a peroxycarboxylic acid or salt thereof, or a peroxysulphonic acid or salt thereof.

The pre-formed peroxyacid or salt thereof is preferably a peroxycarboxylic acid or salt thereof, typically having a chemical structure corresponding to the following chemical formula:

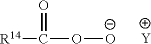

wherein: R¹⁴ is selected from alkyl, aralkyl, cycloalkyl, aryl or heterocyclic groups; the R¹⁴ group can be linear or branched, substituted or unsubstituted; and Y is any suitable counter-ion that achieves electric charge neutrality, preferably Y is selected from hydrogen, sodium or potassium. Preferably, R¹⁴ is a linear or branched, substituted or unsubstituted C₆₋₉ alkyl. Preferably, the peroxyacid or salt thereof is selected from peroxyhexanoic acid, peroxyheptanoic acid, peroxyoctanoic acid, peroxynonanoic acid, peroxydecanoic acid, any salt thereof, or any combination thereof. Particularly preferred peroxyacids are phthalimido-peroxy-alkanoic acids, in particular ε-phthahlimido peroxy hexanoic acid (PAP). Preferably, the peroxyacid or salt thereof has a melting point in the range of from 30° C. to 60° C.

The pre-formed peroxyacid or salt thereof can also be a peroxysulphonic acid or salt thereof, typically having a chemical structure corresponding to the following chemical formula:

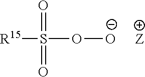

wherein: R¹⁵ is selected from alkyl, aralkyl, cycloalkyl, aryl or heterocyclic groups; the R¹⁵ group can be linear or branched, substituted or unsubstituted; and Z is any suitable counter-ion that achieves electric charge neutrality, preferably Z is selected from hydrogen, sodium or potassium. Preferably R¹⁵ is a linear or branched, substituted or unsubstituted C₆₋₉ alkyl. Preferably such bleach components may be present in the compositions of the invention in an amount from 0.01 to 50 wt % or from 0.1 to 20 wt %.

(2) Sources of hydrogen peroxide include e.g., inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts such as those selected from the group consisting of sodium salts of perborate, percarbonate and mixtures thereof. When employed, inorganic perhydrate salts are typically present in amounts of 0.05 to 40 wt % or 1 to 30 wt % of the overall composition and are typically incorporated into such compositions as a crystalline solid that may be coated. Suitable coatings include inorganic salts such as alkali metal silicate, carbonate or borate salts or mixtures thereof, or organic materials such as water-soluble or dispersible polymers, waxes, oils or fatty soaps. Preferably such bleach components may be present in the compositions of the invention in an amount of 0.01 to 50 wt % or 0.1 to 20 wt %.

(3) The term bleach activator is meant herein as a compound which reacts with hydrogen peroxide to form a peracid via perhydrolysis. The peracid thus formed constitutes the activated bleach. Suitable bleach activators to be used herein include those belonging to the class of esters, amides, imides or anhydrides. Suitable bleach activators are those having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or less than 4 carbon atoms; and L is leaving group. Examples of suitable leaving groups are benzoic acid and derivatives thereof-especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED), sodium 4-[(3,5,5-trimethylhexanoyl)oxy]benzene-1-sulfonate (ISONOBS), 4-(dodecanoyloxy)benzene-1-sulfonate (LOBS), 4-(decanoyloxy)benzene-1-sulfonate, 4-(decanoyloxy)benzoate (DOBS or DOBA), 4-(nonanoyloxy)benzene-1-sulfonate (NOBS), and/or those disclosed in WO98/17767. A family of bleach activators is disclosed in EP624154 and particularly preferred in that family is acetyl triethyl citrate (ATC). ATC or a short chain triglyceride like triacetin has the advantage that it is environmentally friendly. Furthermore, acetyl triethyl citrate and triacetin have good hydrolytical stability in the product upon storage and are efficient bleach activators. Finally, ATC is multifunctional, as the citrate released in the perhydrolysis reaction may function as a builder. Alternatively, the bleaching system may comprise peroxyacids of, for example, the amide, imide, or sulfone type. The bleaching system may also comprise peracids such as 6-(phthalimido) peroxyhexanoic acid (PAP). Suitable bleach activators are also disclosed in WO98/17767. While any suitable bleach activator may be employed, in one aspect of the invention the subject cleaning composition may comprise NOBS, TAED or mixtures thereof. When present, the peracid and/or bleach activator is generally present in the composition in an amount of 0.1 to 60 wt %, 0.5 to 40 wt % or 0.6 to 10 wt % based on the fabric and home care composition. One or more hydrophobic peracids or precursors thereof may be used in combination with one or more hydrophilic peracid or precursor thereof. Preferably such bleach components may be present in the compositions of the invention in an amount of 0.01 to 50 wt %, or 0.1 to 20 wt %.

The amounts of hydrogen peroxide source and peracid or bleach activator may be selected such that the molar ratio of available oxygen (from the peroxide source) to peracid is from 1:1 to 35:1, or even 2:1 to 10:1.

(4) Diacyl peroxides-preferred diacyl peroxide bleaching species include those selected from diacyl peroxides of the general formula: R¹—C(O)—OO—(O)C—R², in which R′ represents a C₆-C₁₈ alkyl, preferably C₆-C₁₂ alkyl group containing a linear chain of at least 5 carbon atoms and optionally containing one or more substituents (e.g. —N⁺(CH₃)₃, —COOH or —CN) and/or one or more interrupting moieties (e.g. —CONH— or —CH═CH—) interpolated between adjacent carbon atoms of the alkyl radical, and R-represents an aliphatic group compatible with a peroxide moiety, such that R¹ and R² together contain a total of 8 to 30 carbon atoms. In one preferred aspect R and R² are linear unsubstituted C₆-C₁₂alkyl chains. Most preferably R¹ and R² are identical. Diacyl peroxides, in which both R¹ and R² are C₆-C₁₂alkyl groups, are particularly preferred. Preferably, at least one of, most preferably only one of, the R groups (R¹ or R²), does not contain branching or pendant rings in the alpha position, or preferably neither in the alpha nor beta positions or most preferably in none of the alpha or beta or gamma positions. In one further preferred embodiment the DAP may be asymmetric, such that preferably the hydrolysis of R1 acyl group is rapid to generate peracid, but the hydrolysis of R2 acyl group is slow.

The tetraacyl peroxide bleaching species is preferably selected from tetraacyl peroxides of the general formula: R³—C(O)—OO—C(O)—(CH₂)n-C(O)—OO—C(O)—R³, in which R³ represents a C₁-C₉ alkyl, or C₃-C₇, group and n represents an integer from 2 to 12, or 4 to 10 inclusive.

Preferably, the diacyl and/or tetraacyl peroxide bleaching species is present in an amount sufficient to provide at least 0.5 ppm, at least 10 ppm, or at least 50 ppm by weight of the wash liquor. In a preferred embodiment, the bleaching species is present in an amount sufficient to provide from 0.5 to 300 ppm, from 30 to 150 ppm by weight of the wash liquor.

Preferably the bleach component comprises a bleach catalyst (5 and 6).

(5) Preferred are organic (non-metal) bleach catalysts include bleach catalyst capable of accepting an oxygen atom from a peroxyacid and/or salt thereof and transferring the oxygen atom to an oxidizeable substrate. Suitable bleach catalysts include but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof.

Suitable iminium cations and polyions include, but are not limited to, N-methyl-3,4-dihydroisoquinolinium tetrafluoroborate, prepared as described in Tetrahedron (1992), 49 (2), 423-38 (e.g. compound 4, p. 433); N-methyl-3,4-dihydroisoquinolinium p-toluene sulphonate, prepared as described in U.S. Pat. No. 5,360,569 (e.g. Column 11, Example 1); and N-octyl-3,4-dihydroisoquinolinium p-toluene sulphonate, prepared as described in U.S. Pat. No. 5,360,568 (e.g. Column 10, Ex. 3).

Suitable iminium zwitterions include, but are not limited to, N-(3-sulfopropyl)-3,4-dihydroisoquinolinium, inner salt, prepared as described in U.S. Pat. No. 5,576,282 (e.g. Column 31, Ex. II); N-[2-(sulphooxy) dodecyl]-3,4-dihydroisoquinolinium, inner salt, prepared as described in U.S. Pat. No. 5,817,614 (e.g. Column 32, Ex. V); 2-[3-[(2-ethylhexyl)oxy]-2-(sulphooxy) propyl]-3,4-dihydroisoquinolinium, inner salt, prepared as described in WO05/047264 (e.g. p. 18, Ex. 8), and 2-[3-[(2-butyloctyl)oxy]-2-(sulphooxy) propyl]-3,4-dihydroisoquinolinium, inner salt.

Suitable modified amine oxygen transfer catalysts include, but are not limited to, 1,2,3,4-tetrahydro-2-methyl-1-isoquinolinol, which can be made according to the procedures described in Tetrahedron Letters (1987), 28(48), 6061-6064. Suitable modified amine oxide oxygen transfer catalysts include, but are not limited to, sodium 1-hydroxy-N-oxy-N-[2-(sulphooxy) decyl]-1,2,3,4-tetrahydroisoquinoline.

Suitable N-sulphonyl imine oxygen transfer catalysts include, but are not limited to, 3-methyl-1,2-benzisothiazole 1,1-dioxide, prepared according to the procedure described in the Journal of Organic Chemistry (1990), 55(4), 1254-61.

Suitable N-phosphonyl imine oxygen transfer catalysts include, but are not limited to, [R-(E)]-N-[(2-chloro-5-nitrophenyl)methylene]-P-phenyl-P-(2,4,6-trimethylphenyl)-phosphinic amide, which can be made according to the procedures described in the Journal of the Chemical Society, Chemical Communications (1994), (22), 2569-70.

Suitable N-acyl imine oxygen transfer catalysts include, but are not limited to, [N(E)]-N-(phenylmethylene) acetamide, which can be made according to the procedures described in Polish Journal of Chemistry (2003), 77(5), 577-590.

Suitable thiadiazole dioxide oxygen transfer catalysts include but are not limited to, 3-methyl-4-phenyl-1,2,5-thiadiazole 1,1-dioxide, which can be made according to the procedures described in U.S. Pat. No. 5,753,599 (Column 9, Ex. 2).

Suitable perfluoroimine oxygen transfer catalysts include, but are not limited to, (Z)-2,2,3,3,4,4,4-heptafluoro-N-(nonafluorobutyl) butanimidoyl fluoride, which can be made according to the procedures described in Tetrahedron Letters (1994), 35(34), 6329-30.

Suitable cyclic sugar ketone oxygen transfer catalysts include, but are not limited to, 1,2:4,5-di-O-isopropylidene-D-erythro-2,3-hexodiuro-2,6-pyranose as prepared in U.S. Pat. No. 6,649,085 (Column 12, Ex. 1).

Preferably, the bleach catalyst comprises an iminium and/or carbonyl functional group and is typically capable of forming an oxaziridinium and/or dioxirane functional group upon acceptance of an oxygen atom, especially upon acceptance of an oxygen atom from a peroxyacid and/or salt thereof. Preferably, the bleach catalyst comprises an oxaziridinium functional group and/or is capable of forming an oxaziridinium functional group upon acceptance of an oxygen atom, especially upon acceptance of an oxygen atom from a peroxyacid and/or salt thereof. Preferably, the bleach catalyst comprises a cyclic iminium functional group, preferably wherein the cyclic moiety has a ring size of from five to eight atoms (including the nitrogen atom), preferably six atoms. Preferably, the bleach catalyst comprises an aryliminium functional group, preferably a bi-cyclic aryliminium functional group, preferably a 3,4-dihydroisoquinolinium functional group. Typically, the imine functional group is a quaternary imine functional group and is typically capable of forming a quaternary oxaziridinium functional group upon acceptance of an oxygen atom, especially upon acceptance of an oxygen atom from a peroxyacid and/or salt thereof. In another aspect, the detergent composition comprises a bleach component having a log P_{o/w} no greater than 0, no greater than −0.5, no greater than −1.0, no greater than −1.5, no greater than −2.0, no greater than −2.5, no greater than −3.0, or no greater than −3.5. The method for determining log P_{o/w} is described in more detail below.

Typically, the bleach ingredient is capable of generating a bleaching species having a X_{SO} of from 0.01 to 0.30, from 0.05 to 0.25, or from 0.10 to 0.20. The method for determining X_{SO} is described in more detail below. For example, bleaching ingredients having an isoquinolinium structure are capable of generating a bleaching species that has an oxaziridinium structure. In this example, the X_{SO} is that of the oxaziridinium bleaching species.

Preferably, the bleach catalyst has a chemical structure corresponding to the following chemical formula:

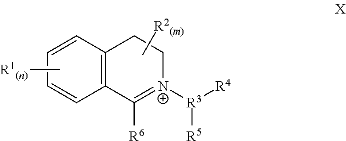

wherein: n and m are independently from 0 to 4, preferably n and m are both 0; each R¹ is independently selected from a substituted or unsubstituted radical selected from the group consisting of hydrogen, alkyl, cycloalkyl, aryl, fused aryl, heterocyclic ring, fused heterocyclic ring, nitro, halo, cyano, sulphonato, alkoxy, keto, carboxylic, and carboalkoxy radicals; and any two vicinal R¹ substituents may combine to form a fused aryl, fused carbocyclic or fused heterocyclic ring; each R² is independently selected from a substituted or unsubstituted radical independently selected from the group consisting of hydrogen, hydroxy, alkyl, cycloalkyl, alkaryl, aryl, aralkyl, alkylenes, heterocyclic ring, alkoxys, arylcarbonyl groups, carboxyalkyl groups and amide groups; any R² may be joined together with any other of R² to form part of a common ring; any geminal R² may combine to form a carbonyl; and any two R² may combine to form a substituted or unsubstituted fused unsaturated moiety; R³ is a C₁ to C₂₀ substituted or unsubstituted alkyl; R⁴ is hydrogen or the moiety Qₜ-A, wherein: Q is a branched or unbranched alkylene, t=0 or 1 and A is an anionic group selected from the group consisting of OSO₃⁻, SO₃⁻, CO₂⁻, OCO₂⁻, OPO₃²⁻, OPO₃H⁻ and OPO₂⁻; R⁵ is hydrogen or the moiety —CR¹¹R¹²—Y-G_{b}-Y_{c}—[(CR⁹R¹⁰)_{y}—O]ₖ—R⁸, wherein: each Y is independently selected from the group consisting of O, S, N—H, or N—R⁸; and each R⁸ is independently selected from the group consisting of alkyl, aryl and heteroaryl, said moieties being substituted or unsubstituted, and whether substituted or unsubsituted said moieties having less than 21 carbons; each G is independently selected from the group consisting of CO, SO₂, SO, PO and PO₂; R⁹ and R¹⁰ are independently selected from the group consisting of H and C₁-C₄ alkyl; R¹¹ and R¹² are independently selected from the group consisting of H and alkyl, or when taken together may join to form a carbonyl; b=0 or 1; c can=0 or 1, but c must=0 if b=0; y is an integer from 1 to 6; k is an integer from 0 to 20; R⁶ is H, or an alkyl, aryl or heteroaryl moiety; said moieties being substituted or unsubstituted; and X, if present, is a suitable charge balancing counterion, preferably X is present when R⁴ is hydrogen, suitable X, include but are not limited to: chloride, bromide, sulphate, methosulphate, sulphonate, p-toluenesulphonate, borontetraflouride and phosphate.

In one embodiment of the present invention, the bleach catalyst has a structure corresponding to general formula below:

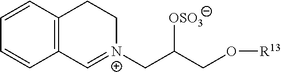

wherein R¹³ is a branched alkyl group containing from three to 24 carbon atoms (including the branching carbon atoms) or a linear alkyl group containing from one to 24 carbon atoms; preferably R¹³ is a branched alkyl group containing from eight to 18 carbon atoms or linear alkyl group containing from eight to eighteen carbon atoms; preferably R¹³ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl; preferably R¹³ is selected from the group consisting of 2-butyloctyl, 2-pentylnonyl, 2-hexyldecyl, iso-tridecyl and iso-pentadecyl.

Preferably the bleach component comprises a source of peracid in addition to bleach catalyst, particularly organic bleach catalyst. The source of peracid may be selected from (a) pre-formed peracid; (b) percarbonate, perborate or persulfate salt (hydrogen peroxide source) preferably in combination with a bleach activator; and (c) perhydrolase enzyme and an ester for forming peracid in situ in the presence of water in a textile or hard surface treatment step.

When present, the peracid and/or bleach activator is generally present in the composition in an amount of from 0.1 to 60 wt %, from 0.5 to 40 wt % or from 0.6 to 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or 2:1 to 10:1.

(6) Metal-containing Bleach Catalysts—The bleach component may be provided by a catalytic metal complex. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243. Preferred catalysts are described in WO09/839406, U.S. Pat. No. 6,218,351 and WO00/012667. Particularly preferred are transition metal catalyst or ligands therefore that are cross-bridged polydentate N-donor ligands.

If desired, the compositions herein can be catalyzed by means of a manganese compound. Such compounds and levels of use are well known in the art and include, e.g., the manganese-based catalysts disclosed in U.S. Pat. No. 5,576,282.

Cobalt bleach catalysts useful herein are known, and are described e.g., in U.S. Pat. Nos. 5,597,936; 5,595,967. Such cobalt catalysts are readily prepared by known procedures, such as taught e.g., in U.S. Pat. Nos. 5,597,936 and 5,595,967.

Compositions herein may also suitably include a transition metal complex of ligands such as bispidones (U.S. Pat. No. 7,501,389) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from 0.005 to 25 ppm, from 0.05 to 10 ppm, or from 0.1 to 5 ppm, of the MRL in the wash liquor.

Suitable transition-metals in the instant transition-metal bleach catalyst include e.g. manganese, iron and chromium. Suitable MRLs include 5,12-diethyl-1,5,8,12-tetraazabicyclo[6.6.2]hexadecane. Suitable transition metal MRLs are readily prepared by known procedures, such as taught e.g. in U.S. Pat. No. 6,225,464 and WO00/32601.

(7) Photobleaches-suitable photobleaches include e.g., sulfonated zinc phthalocyanine sulfonated aluminium phthalocyanines, xanthene dyes and mixtures thereof. Preferred bleach components for use in the present compositions of the invention comprise a hydrogen peroxide source, bleach activator and/or organic peroxyacid, optionally generated in situ by the reaction of a hydrogen peroxide source and bleach activator, in combination with a bleach catalyst. Preferred bleach components comprise bleach catalysts, preferably organic bleach catalysts, as described above.

Particularly preferred bleach components are the bleach catalysts in particular the organic bleach catalysts.

Exemplary bleaching systems are also described, e.g. in WO2007/087258, WO2007/087244, WO2007/087259 and WO2007/087242.

### Fabric Hueing Agents

A composition of the invention may also comprise a fabric hueing agent. Suitable fabric hueing agents include dyes, dye-clay conjugates, and pigments. Suitable dyes include small molecule dyes and polymeric dyes. Suitable small molecule dyes include small molecule dyes selected from the group consisting of dyes falling into the Color Index (C.I.) classifications of Direct Blue, Direct Red, Direct Violet, Acid Blue, Acid Red, Acid Violet, Basic Blue, Basic Violet and Basic Red, or mixtures thereof.

In another aspect, suitable small molecule dyes include small molecule dyes selected from the group consisting of Color Index (Society of Dyers and Colorists, Bradford, UK) numbers Direct Violet 9, Direct Violet 35, Direct Violet 48, Direct Violet 51, Direct Violet 66, Direct Violet 99, Direct Blue 1, Direct Blue 71, Direct Blue 80, Direct Blue 279, Acid Red 17, Acid Red 73, Acid Red 88, Acid Red 150, Acid Violet 15, Acid Violet 17, Acid Violet 24, Acid Violet 43, Acid Red 52, Acid Violet 49, Acid Violet 50, Acid Blue 15, Acid Blue 17, Acid Blue 25, Acid Blue 29, Acid Blue 40, Acid Blue 45, Acid Blue 75, Acid Blue 80, Acid Blue 83, Acid Blue 90 and Acid Blue 113, Acid Black 1, Basic Violet 1, Basic Violet 3, Basic Violet 4, Basic Violet 10, Basic Violet 35, Basic Blue 3, Basic Blue 16, Basic Blue 22, Basic Blue 47, Basic Blue 66, Basic Blue 75, Basic Blue 159 and mixtures thereof. In another aspect, suitable small molecule dyes include small molecule dyes selected from the group consisting of Color Index (Society of Dyers and Colorists, Bradford, UK) numbers Acid Violet 17, Acid Violet 43, Acid Red 52, Acid Red 73, Acid Red 88, Acid Red 150, Acid Blue 25, Acid Blue 29, Acid Blue 45, Acid Blue 113, Acid Black 1, Direct Blue 1, Direct Blue 71, Direct Violet 51 and mixtures thereof. In another aspect, suitable small molecule dyes include small molecule dyes selected from the group consisting of Color Index (Society of Dyers and Colorists, Bradford, UK) numbers Acid Violet 17, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing conjugated chromogens (dye-polymer conjugates) and polymers with chromogens co-polymerized into the backbone of the polymer and mixtures thereof.

In another aspect, suitable polymeric dyes include polymeric dyes selected from the group consisting of fabric-substantive colorants sold under the name of Liquitint® (Milliken), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof.

In still another aspect, suitable polymeric dyes include polymeric dyes selected from the group consisting of Liquitint® Violet CT, carboxymethyl cellulose (CMC) conjugated with a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colorants, alkoxylated thiophene polymeric colorants, and mixtures thereof.

Preferred hueing dyes include the whitening agents found in WO08/87497. These whitening agents may be characterized by the following structure (I):

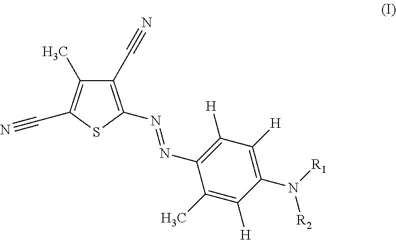

wherein R₁ and R₂ can independently be selected from:

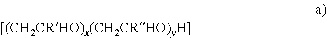

wherein R′ is selected from the group consisting of H, CH₃, CH₂O(CH₂CH₂O)_{z}H, and mixtures thereof; wherein R″ is selected from the group consisting of H, CH₂O(CH₂CH₂O)_{z}H, and mixtures thereof; wherein x+y≤5; wherein y≥1; and wherein z=0 to 5;

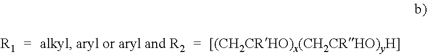

wherein R′ is selected from the group consisting of H, CH₃, CH₂O(CH₂CH₂O)_{z}H, and mixtures thereof; wherein R″ is selected from the group consisting of H, CH₂O(CH₂CH₂O)_{z}H, and mixtures thereof; wherein x+y≤10; wherein y≥1; and wherein z=0 to 5;

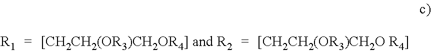

wherein R₃ is selected from the group consisting of H, (CH₂CH₂O)_{z}H, and mixtures thereof; and wherein z=0 to 10;
wherein R₄ is selected from the group consisting of (C₁-C₁₆)alkyl, aryl groups, and mixtures thereof; and
d) wherein R1 and R2 can independently be selected from the amino addition product of styrene oxide, glycidyl methyl ether, isobutyl glycidyl ether, isopropylglycidyl ether, t-butyl glycidyl ether, 2-ethylhexylgycidyl ether, and glycidylhexadecyl ether, followed by the addition of from 1 to 10 alkylene oxide units.

A preferred whitening agent of the present invention may be characterized by the following structure (II):

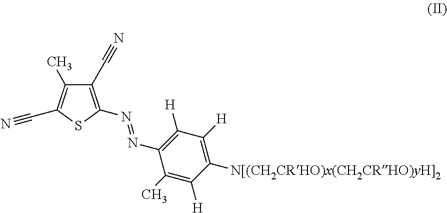

wherein R′ is selected from the group consisting of H, CH₃, CH₂O(CH₂CH₂O)_{z}H, and mixtures thereof; wherein R″ is selected from the group consisting of H, CH₂O(CH₂CH₂O)_{z}H, and mixtures thereof; wherein x+y≤5; wherein y≥1; and wherein z=0 to 5.

A further preferred whitening agent of the present invention may be characterized by the following structure (III):

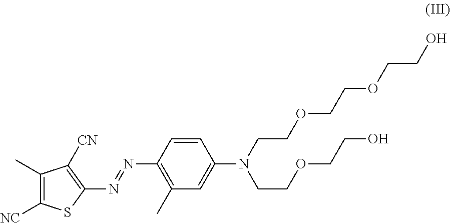 [SMILES: Cc1cc(N(CCOCCO)CCOCCOCCO)ccc1/N=N/c1sc(C#N)c(C)c1C#N]

typically comprising a mixture having a total of 5 EO groups. Suitable preferred molecules are those in Structure I having the following pendant groups in “part a” above.

TABLE 1

| | R1 | | | | R2 | | | |
|---|---|---|---|---|---|---|---|---|
| | R′ | R″ | X | y | R′ | R″ | x | y |
| A | H | H | 3 | 1 | H | H | 0 | 1 |
| B | H | H | 2 | 1 | H | H | 1 | 1 |
| c = b | H | H | 1 | 1 | H | H | 2 | 1 |
| d = a | H | H | 0 | 1 | H | H | 3 | 1 |

Further whitening agents of use include those described in US2008/34511 (Unilever). A preferred agent is “Violet 13”.

Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3-alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof.

In another aspect, suitable pigments include pigments selected from the group consisting of Ultramarine Blue (C.I. Pigment Blue 29), Ultramarine Violet (C.I. Pigment Violet 15) and mixtures thereof.

The aforementioned fabric hueing agents can be used in combination (any mixture of fabric hueing agents can be used). Suitable hueing agents are described in more detail in U.S. Pat. No. 7,208,459. Preferred levels of dye in compositions of the invention are 0.00001 to 0.5 wt %, or 0.0001 to 0.25 wt %. The concentration of dyes preferred in water for the treatment and/or cleaning step is from 1 ppb to 5 ppm, 10 ppb to 5 ppm or 20 ppb to 5 ppm. In preferred compositions, the concentration of surfactant will be from 0.2 to 3 g/l.

### Encapsulates

A composition of the invention may comprise an encapsulate comprising a core and a shell having an inner and outer surface. Said shell encapsulates said core.

In one aspect, of said encapsulate, said core may comprise a material selected from the group consisting of perfumes; brighteners; dyes; insect repellants; silicones; waxes; flavors; vitamins; fabric softening agents; skin care agents in one aspect, paraffins; enzymes; anti-bacterial agents; bleaches; sensates; and mixtures thereof; and said shell may comprise a material selected from the group consisting of polyethylenes; polyamides; polyvinylalcohols, optionally containing other co-monomers; polystyrenes; polyisoprenes; polycarbonates; polyesters; polyacrylates; aminoplasts, in one aspect said aminoplast may comprise a polyureas, polyurethane, and/or polyureaurethane, in one aspect said polyurea may comprise polyoxymethyleneurea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof.

In one aspect of said encapsulate, said core may comprise perfume.

In one aspect of said encapsulate, said shell may comprise melamine formaldehyde and/or cross-linked melamine formaldehyde.

In a one aspect, suitable encapsulates may comprise a core material and a shell, said shell at least partially surrounding said core material, is disclosed. At least 75%, 85% or 90% of said encapsulates may have a fracture strength of from 0.2 to 10 MPa, from 0.4 to 5 MPa, from 0.6 to 3.5 MPa, or from 0.7 to 3 MPa; and a benefit agent leakage of from 0 to 30%, from 0 to 20%, or from 0 to 5%.

In one aspect, at least 75%, 85% or 90% of said encapsulates may have a particle size from 1 to 80 microns, from 5 to 60 microns, from 10 to 50 microns, or from 15 to 40 microns.

In one aspect, at least 75%, 85% or 90% of said encapsulates may have a particle wall thickness from 30 to 250 nm, from 80 to 180 nm, or from 100 to 160 nm.

In one aspect, said encapsulates' core material may comprise a material selected from the group consisting of a perfume raw material and/or optionally a material selected from the group consisting of vegetable oil, including neat and/or blended vegetable oils including castor oil, coconut oil, cottonseed oil, grape oil, rapeseed, soybean oil, corn oil, palm oil, linseed oil, safflower oil, olive oil, peanut oil, coconut oil, palm kernel oil, castor oil, lemon oil and mixtures thereof; esters of vegetable oils, esters, including dibutyl adipate, dibutyl phthalate, butyl benzyl adipate, benzyl octyl adipate, tricresyl phosphate, trioctyl phosphate and mixtures thereof; straight or branched chain hydrocarbons, including those straight or branched chain hydrocarbons having a boiling point of greater than about 80° C.; partially hydrogenated terphenyls, dialkyl phthalates, alkyl biphenyls, including monoisopropylbiphenyl, alkylated naphthalene, including dipropylnaphthalene, petroleum spirits, including kerosene, mineral oil and mixtures thereof; aromatic solvents, including benzene, toluene and mixtures thereof; silicone oils; and mixtures thereof.

In one aspect, said encapsulates' wall material may comprise a suitable resin including the reaction product of an aldehyde and an amine, suitable aldehydes include formaldehyde. Suitable amines include melamine, urea, benzoguanamine, glycoluril, and mixtures thereof. Suitable melamines include methylol melamine, methylated methylol melamine, imino melamine and mixtures thereof. Suitable ureas include dimethylol urea, methylated dimethylol urea, urea-resorcinol, and mixtures thereof.

In one aspect, suitable formaldehyde scavengers may be employed with the encapsulates e.g., in a capsule slurry and/or added to a composition before, during or after the encapsulates are added to such composition. Suitable capsules may be made by the following teaching of US2008/0305982; and/or US2009/0247449.

In a preferred aspect the composition can also comprise a deposition aid, preferably consisting of the group comprising cationic or nonionic polymers. Suitable polymers include cationic starches, cationic hydroxyethylcellulose, polyvinylformaldehyde, locust bean gum, mannans, xyloglucans, tamarind gum, polyethyleneterephthalate and polymers containing dimethylaminoethyl methacrylate, optionally with one or monomers selected from the group comprising acrylic acid and acrylamide.

### Perfumes

In one aspect, the composition of the invention also comprises a perfume that comprises one or more perfume raw materials selected from the group consisting of 1,1′-oxybis-2-propanol; 1,4-cyclohexanedicarboxylic acid, diethyl ester; (ethoxymethoxy)cyclododecane; 1,3-nonanediol, monoacetate; (3-methylbutoxy) acetic acid, 2-propenyl ester; beta-methyl cyclododecaneethanol; 2-methyl-3-[(1,7,7-trimethylbicyclo[2.2.1]hept-2-yl)oxy]-1-propanol; oxacyclohexadecan-2-one; alpha-methyl-benzenemethanol acetate; trans-3-ethoxy-1,1,5-trimethylcyclohexane; 4-(1,1-dimethylethyl)cyclohexanol acetate; dodecahydro-3a,6,6,9a-tetramethylnaphtho[2,1-b]furan; beta-methyl benzenepropanal; beta-methyl-3-(1-methylethyl)benzenepropanal; 4-phenyl-2-butanone; 2-methylbutanoic acid, ethyl ester; benzaldehyde; 2-methylbutanoic acid, 1-methylethyl ester; dihydro-5-pentyl-2 (3H) furanone; (2E)-1-(2,6,6-trimethyl-2-cyclohexen-1-yl)-2-buten-1-one; dodecanal; undecanal; 2-ethyl-alpha, alpha-dimethylbenzenepropanal; decanal; alpha, alpha-dimethylbenzeneethanol acetate; 2-(phenylmethylene) octanal; 2-[3-[4-(1,1-dimethylethyl)phenyl]-2-methylpropylidene]amino]benzoic acid, methyl ester; 1-(2,6,6-trimethyl-3-cyclohexen-1-yl)-2-buten-1-one; 2-pentylcyclopentanone; 3-oxo-2-pentyl cyclopentaneacetic acid, methyl ester; 4-hydroxy-3-methoxybenzaldehyde; 3-ethoxy-4-hydroxybenzaldehyde; 2-heptylcyclopentanone; 1-(4-methylphenyl) ethanone; (3E)-4-(2,6,6-trimethyl-1-cyclohexen-1-yl)-3-buten-2-one; (3E)-4-(2,6,6-trimethyl-2-cyclohexen-1-yl)-3-buten-2-one; benzeneethanol; 2H-1-benzopyran-2-one; 4-methoxybenzaldehyde; 10-undecenal; propanoic acid, phenylmethyl ester; beta-methylbenzenepentanol; 1,1-diethoxy-3,7-dimethyl-2,6-octadiene; alpha, alpha-dimethylbenzeneethanol; (2E)-1-(2,6,6-trimethyl-1-cyclohexen-1-yl)-2-buten-1-one; acetic acid, phenylmethyl ester; cyclohexanepropanoic acid, 2-propenyl ester; hexanoic acid, 2-propenyl ester; 1,2-dimethoxy-4-(2-propenyl)benzene; 1,5-dimethyl-bicyclo[3.2.1]octan-8-one oxime; 4-(4-hydroxy-4-methylpentyl)-3-cyclohexene-1-carboxaldehyde; 3-buten-2-ol; 2-[2,4 (or 3,5)-dimethyl-3-cyclohexen-1-yl]methylene]amino]benzoic acid, methyl ester; 8-cyclohexadecen-1-one; methyl ionone; 2,6-dimethyl-7-octen-2-ol; 2-methoxy-4-(2-propenyl) phenol; (2E)-3,7-dimethyl-2,6-Octadien-1-ol; 2-hydroxy-Benzoic acid, (3Z)-3-hexenyl ester; 2-tridecenenitrile; 4-(2,2-dimethyl-6-methylenecyclohexyl)-3-methyl-3-buten-2-one; tetrahydro-4-methyl-2-(2-methyl-1-propenyl)-2H-pyran; Acetic acid, (2-methylbutoxy)-, 2-propenyl ester; Benzoic acid, 2-hydroxy, 3-methylbutyl ester; 2-Buten-1-one, 1-(2,6,6-trimethyl-1-cyclohexen-1-yl)-, (Z)—; Cyclopentanecarboxylic acid, 2-hexyl-3-oxo-, methyl ester; Benzenepropanal, 4-ethyl-.alpha.,.alpha.-dimethyl-; 3-Cyclohexene-1-carboxaldehyde, 3-(4-hydroxy-4-methylpentyl)-; Ethanone, 1-(2,3,4,7,8,8a-hexahydro-3,6,8,8-tetramethyl-1H-3a,7-methanoazulen-5-yl)-, [3R-(3.alpha.,3a.beta.,7.beta.,8a.alpha.)]-; Undecanal, 2-methyl-2H-Pyran-2-one, 6-butyltetrahydro-; Benzenepropanal, 4-(1,1-dimethylethyl)-.alpha.-methyl-; 2(3H)-Furanone, 5-heptyldihydro-; Benzoic acid, 2-[(7-hydroxy-3,7-dimethyloctylidene)amino]-, methyl; Benzoic acid, 2-hydroxy-, phenylmethyl ester; Naphthalene, 2-methoxy-; 2-Cyclopenten-1-one, 2-hexyl-; 2(3H)-Furanone, 5-hexyldihydro-; Oxiranecarboxylic acid, 3-methyl-3-phenyl-, ethyl ester; 2-Oxabicyclo[2.2.2]octane, 1,3,3-trimethyl-; Benzenepentanol, .gamma.-methyl-; 3-Octanol, 3,7-dimethyl-; 3,7-dimethyl-2,6-octadienenitrile; 3,7-dimethyl-6-octen-1-ol; Terpineol acetate; 2-methyl-6-methylene-7-Octen-2-ol, dihydro derivative; 3a,4,5,6,7,7a-hexahydro-4,7-Methano-1H-inden-6-ol propanoate; 3-methyl-2-buten-1-ol acetate; (Z)-3-Hexen-1-ol acetate; 2-ethyl-4-(2,2,3-trimethyl-3-cyclopenten-1-yl)-2-buten-1-ol; 4-(octahydro-4,7-methano-5H-inden-5-ylidene)-butanal; 3-2,4-dimethyl-cyclohexene-1-carboxaldehyde; 1-(1,2,3,4,5,6,7,8-octahydro-2,3,8,8-tetramethyl-2-naphthalenyl)-ethanone; 2-hydroxy-benzoic acid, methyl ester; 2-hydroxy-benzoic acid, hexyl ester; 2-phenoxy-ethanol; 2-hydroxy-benzoic acid, pentyl ester; 2,3-heptanedione; 2-hexen-1-ol; 6-Octen-2-ol, 2,6-dimethyl-; damascone (alpha, beta, gamma or delta or mixtures thereof), 4,7-Methano-1H-inden-6-ol, 3a,4,5,6,7,7a-hexahydro-, acetate; 9-Undecenal; 8-Undecenal; Isocyclocitral; Ethanone, 1-(1,2,3,5,6,7,8,8a-octahydro-2,3,8,8-tetramethyl-2-naphthalenyl)-; 3-Cyclohexene-1-carboxaldehyde, 3,5-dimethyl-; 3-Cyclohexene-1-carboxaldehyde, 2,4-dimethyl-; 1,6-Octadien-3-ol, 3,7-dimethyl-; 1,6-Octadien-3-ol, 3,7-dimethyl-, acetate; Lilial (p-t-Bucinal), and Cyclopentanone, 2-[2-(4-methyl-3-cyclohexen-1-yl) propyl]- and 1-methyl-4-(1-methylethenyl)cyclohexene and mixtures thereof.

In one aspect, the composition may comprise an encapsulated perfume particle comprising either a water-soluble hydroxylic compound or melamine-formaldehyde or modified polyvinyl alcohol. In one aspect the encapsulate comprises (a) an at least partially water-soluble solid matrix comprising one or more water-soluble hydroxylic compounds, preferably starch; and (b) a perfume oil encapsulated by the solid matrix.

In a further aspect the perfume may be pre-complexed with a polyamine, preferably a polyethylenimine so as to form a Schiff base.

### Polymers

A composition of the invention may also comprise one or more polymers. Examples are carboxymethylcellulose, poly(vinyl-pyrrolidone), poly(ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

The composition may comprise one or more amphiphilic cleaning polymers such as the compound having the following general structure: bis((C₂H₅O)(C₂H₄O)n)(CH₃)—N⁺—CₓH₂ₓ—N⁺—(CH₃)-bis((C₂H₅O)(C₂H₄O)n), wherein n=from 20 to 30, and x=from 3 to 8, or sulphated or sulphonated variants thereof.

The composition may comprise amphiphilic alkoxylated grease cleaning polymers which have balanced hydrophilic and hydrophobic properties such that they remove grease particles from fabrics and surfaces. Specific embodiments of the amphiphilic alkoxylated grease cleaning polymers of the present invention comprise a core structure and a plurality of alkoxylate groups attached to that core structure. These may comprise alkoxylated polyalkylenimines, preferably having an inner polyethylene oxide block and an outer polypropylene oxide block.

Alkoxylated polycarboxylates such as those prepared from polyacrylates are useful herein to provide additional grease removal performance. Such materials are described in WO91/08281 and PCT90/01815. Chemically, these materials comprise polyacrylates having one ethoxy side-chain per every 7-8 acrylate units. The side-chains are of the formula —(CH₂CH₂O)ₘ(CH₂)ₙCH₃ wherein m is 2-3 and n is 6-12. The side-chains are ester-linked to the polyacrylate “backbone” to provide a “comb” polymer type structure. The molecular weight can vary, but is typically in the range of 2000 to 50,000. Such alkoxylated polycarboxylates can comprise from 0.05 wt % to 10 wt % of the compositions herein.

The isoprenoid-derived surfactants of the present invention, and their mixtures with other cosurfactants and other adjunct ingredients, are particularly suited to be used with an amphilic graft co-polymer, preferably the amphilic graft co-polymer comprises (i) polyethyelene glycol backbone; and (ii) and at least one pendant moiety selected from polyvinyl acetate, polyvinyl alcohol and mixtures thereof. A preferred amphilic graft co-polymer is Sokalan HP22, supplied from BASF. Suitable polymers include random graft copolymers, preferably a polyvinyl acetate grafted polyethylene oxide copolymer having a polyethylene oxide backbone and multiple polyvinyl acetate side chains. The molecular weight of the polyethylene oxide backbone is preferably 6000 and the weight ratio of the polyethylene oxide to polyvinyl acetate is 40 to 60 and no more than 1 grafting point per 50 ethylene oxide units.

### Carboxylate Polymer

A composition of the present invention may include one or more carboxylate polymers such as a maleate/acrylate random copolymer or polyacrylate homopolymer. In one aspect, the carboxylate polymer is a polyacrylate homopolymer having a molecular weight of from 4,000 to 9,000 Da, or from 6,000 to 9,000 Da.

### Soil Release Polymer

A composition of the present invention may also include one or more soil release polymers having a structure as defined by one of the following structures (I), (II) or (III):

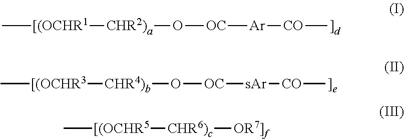

wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R₄, R⁵ and R⁶ are independently selected from H or C₁-C₁₈ n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex, SF-2 and SRP6 supplied by Rhodia. Other suitable soil release polymers include Texcare polymers, including Texcare SRA100, SRA300, SRN100, SRN170, SRN240, SRN300 and SRN325 supplied by Clariant. Other suitable soil release polymers are Marloquest polymers, such as Marloquest SL supplied by Sasol.

### Cellulosic Polymer

A composition of the present invention may also include one or more cellulosic polymers including those selected from alkyl cellulose, alkyl alkoxyalkyl cellulose, carboxyalkyl cellulose, alkyl carboxyalkyl cellulose. In one aspect, the cellulosic polymers are selected from the group comprising carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from 100,000 to 300,000 Da.

### Dye Transfer Inhibiting Agents

A composition of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a composition, the dye transfer inhibiting agents may be present at levels from 0.0001 to 10 wt %, from 0.01 to 5 wt % or from 0.1 to 3 wt %.

### Brighteners

A composition of the present invention can also contain additional components that may tint articles being cleaned, such as fluorescent brighteners.

The composition may comprise C.I. fluorescent brightener 260 in alpha-crystalline form having the following structure:

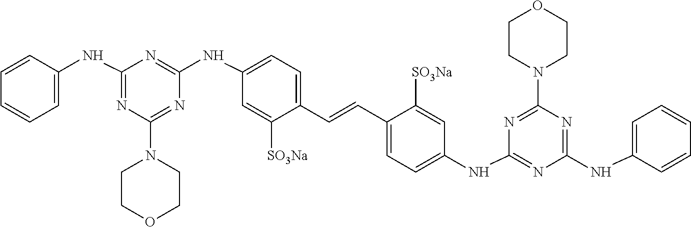

In one aspect, the brightener is a cold water soluble brightener, such as the C.I. fluorescent brightener 260 in alpha-crystalline form. In one aspect the brightener is predominantly in alpha-crystalline form, which means that typically at least 50 wt %, at least 75 wt %, at least 90 wt %, at least 99 wt %, or even substantially all, of the C.I. fluorescent brightener 260 is in alpha-crystalline form.

The brightener is typically in micronized particulate form, having a weight average primary particle size of from 3 to 30 micrometers, from 3 micrometers to 20 micrometers, or from 3 to 10 micrometers.

The composition may comprise C.I. fluorescent brightener 260 in beta-crystalline form, and the weight ratio of: (i) C.I. fluorescent brightener 260 in alpha-crystalline form, to (ii) C.I. fluorescent brightener 260 in beta-crystalline form may be at least 0.1, or at least 0.6. BE680847 relates to a process for making C.I fluorescent brightener 260 in alpha-crystalline form.

Commercial optical brighteners which may be useful in the present invention can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982). Specific nonlimiting examples of optical brighteners which are useful in the present compositions are those identified in U.S. Pat. Nos. 4,790,856 and 3,646,015.

A further suitable brightener has the structure below:

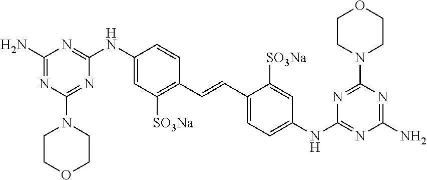

Suitable fluorescent brightener levels include lower levels of from 0.01 wt %, from 0.05 wt %, from 0.1 wt % or from 0.2 wt % to upper levels of 0.5 wt % or 0.75 wt %.

In one aspect the brightener may be loaded onto a clay to form a particle. Silicate salts—The compositions of the present invention can also contain silicate salts, such as sodium or potassium silicate. The composition may comprise of from 0 wt % to less than 10 wt % silicate salt, to 9 wt %, or to 8 wt %, or to 7 wt %, or to 6 wt %, or to 5 wt %, or to 4 wt %, or to 3 wt %, or even to 2 wt %, and from above 0 wt %, or from 0.5 wt %, or from 1 wt % silicate salt. A suitable silicate salt is sodium silicate.

### Dispersants

A composition of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

### Enzyme Stabilizers

Enzymes for use in compositions can be stabilized by various techniques. The enzymes employed herein can be stabilized by the presence of water-soluble sources of calcium and/or magnesium ions. Examples of conventional stabilizing agents are, e.g. a polyol such as propylene glycol or glycerol, a sugar or sugar alcohol, a peptide aldehyde, lactic acid, boric acid, or a boric acid derivative, e.g. an aromatic borate ester, or a phenyl boronic acid derivative such as 4-formylphenyl boronic acid, and the composition may be formulated as described in, for example, WO92/19709 and WO92/19708 In case of aqueous compositions comprising protease, a reversible protease inhibitor, such as a boron compound including borate, 4-formyl phenylboronic acid, phenylboronic acid and derivatives thereof, or compounds such as calcium formate, sodium formate and 1,2-propane diol can be added to further improve stability. The peptide aldehyde may be of the formula B₂—B₁—B₀—R wherein: R is hydrogen, CH₃, CX₃, CHX₂, or CH₂X, wherein X is a halogen atom; B₀ is a phenylalanine residue with an OH substituent at the p-position and/or at the m-position; B₁ is a single amino acid residue; and B₂ consists of one or more amino acid residues, optionally comprising an N-terminal protection group. Preferred peptide aldehydes include but are not limited to: Z-RAY—H, Ac-GAY—H, Z-GAY—H, Z-GAL-H, Z-GAF—H, Z-GAV—H, Z—RVY—H, Z-LVY-H, Ac-LGAY—H, Ac—FGAY—H, Ac—YGAY—H, Ac—FGVY-H or Ac-WLVY-H, where Z is benzyloxycarbonyl and Ac is acetyl.

### Solvents

Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally friendly solvents and mixtures thereof.

### Structurant/Thickeners

Structured liquids can either be internally structured, whereby the structure is formed by primary ingredients (e.g., surfactant material) and/or externally structured by providing a three-dimensional matrix structure using secondary ingredients (e.g. polymers, clay and/or silicate material). The composition may comprise a structurant, from 0.01 to 5 wt %, or from 0.1 to 2.0 wt %. The structurant is typically selected from the group consisting of diglycerides and triglycerides, ethylene glycol distearate, microcrystalline cellulose, cellulose-based materials, microfiber cellulose, hydrophobically modified alkali-swellable emulsions such as Polygel W30 (3VSigma), biopolymers, xanthan gum, gellan gum, and mixtures thereof. A suitable structurant includes hydrogenated castor oil, and non-ethoxylated derivatives thereof. A suitable structurant is disclosed in U.S. Pat. No. 6,855,680. Such structurants have a thread-like structuring system having a range of aspect ratios. Other suitable structurants and the processes for making them are described in WO10/034736.

### Conditioning Agents

A composition of the present invention may include a high melting point fatty compound. The high melting point fatty compound useful herein has a melting point of 25° C. or higher and is selected from the group consisting of fatty alcohols, fatty acids, fatty alcohol derivatives, fatty acid derivatives, and mixtures thereof. Such compounds of low melting point are not intended to be included in this section. Non-limiting examples of the high melting point compounds are found in International Cosmetic Ingredient Dictionary, Fifth Edition, 1993, and CTFA Cosmetic Ingredient

### Handbook, Second Edition, 1992.

The high melting point fatty compound is included in the composition at a level of from 0.1 to 40 wt %, from 1 to 30 wt %, from 1.5 to 16 wt %, from 1.5 to 8 wt % in view of providing improved conditioning benefits such as slippery feel during the application to wet hair, softness and moisturized feel on dry hair.

The compositions of the present invention may contain a cationic polymer. Concentrations of the cationic polymer in the composition typically range from 0.05 to 3 wt %, from 0.075 to 2.0 wt %, or from 0.1 to 1.0 wt %. Suitable cationic polymers will have cationic charge densities of at least 0.5 meq/gm, at least 0.9 meq/gm, at least 1.2 meq/gm, at least 1.5 meq/gm, or less than 7 meq/gm, and less than 5 meq/gm, at the pH of intended use of the composition, which pH will generally range from pH3 to pH9, or between pH4 and pH8. Herein, “cationic charge density” of a polymer refers to the ratio of the number of positive charges on the polymer to the molecular weight of the polymer. The average molecular weight of such suitable cationic polymers will generally be between 10,000 and 10 million, between 50,000 and 5 million, or between 100,000 and 3 million.

Suitable cationic polymers for use in the compositions of the present invention contain cationic nitrogen-containing moieties such as quaternary ammonium or cationic protonated amino moieties. Any anionic counterions can be used in association with the cationic polymers so long as the polymers remain soluble in water, in the composition, or in a coacervate phase of the composition, and so long as the counterions are physically and chemically compatible with the essential components of the composition or do not otherwise unduly impair composition performance, stability or aesthetics. Nonlimiting examples of such counterions include halides (e.g., chloride, fluoride, bromide, iodide), sulfate and methylsulfate.

Nonlimiting examples of such polymers are described in the CTFA Cosmetic Ingredient Dictionary, 3rd edition, edited by Estrin, Crosley, and Haynes, (The Cosmetic, Toiletry, and Fragrance Association, Inc., Washington, D.C. (1982)).

Other suitable cationic polymers for use in the composition include polysaccharide polymers, cationic guar gum derivatives, quaternary nitrogen-containing cellulose ethers, synthetic polymers, copolymers of etherified cellulose, guar and starch. When used, the cationic polymers herein are either soluble in the composition or are soluble in a complex coacervate phase in the composition formed by the cationic polymer and the anionic, amphoteric and/or zwitterionic surfactant component described hereinbefore. Complex coacervates of the cationic polymer can also be formed with other charged materials in the composition. Suitable cationic polymers are described in U.S. Pat. Nos. 3,962,418; 3,958,581; and US2007/0207109.

The composition of the present invention may include a nonionic polymer as a conditioning agent. Polyalkylene glycols having a molecular weight of more than 1000 are useful herein. Useful are those having the following general formula:

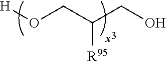

wherein R⁹⁵ is selected from the group consisting of H, methyl, and mixtures thereof. Conditioning agents, and in particular silicones, may be included in the composition. The conditioning agents useful in the compositions of the present invention typically comprise a water insoluble, water dispersible, non-volatile, liquid that forms emulsified, liquid particles. Suitable conditioning agents for use in the composition are those conditioning agents characterized generally as silicones (e.g., silicone oils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein. Such conditioning agents should be physically and chemically compatible with the essential components of the composition, and should not otherwise unduly impair composition stability, aesthetics or performance.

The concentration of the conditioning agent in the composition should be sufficient to provide the desired conditioning benefits. Such concentration can vary with the conditioning agent, the conditioning performance desired, the average size of the conditioning agent particles, the type and concentration of other components, and other like factors.

The concentration of the silicone conditioning agent typically ranges from 0.01 to 10 wt %. Non-limiting examples of suitable silicone conditioning agents, and optional suspending agents for the silicone, are described in U.S. Reissue Pat. No. 34,584; U.S. Pat. Nos. 5,104,646; 5,106,609; 4,152,416; 2,826,551; 3,964,500; 4,364,837; 6,607,717; 6,482,969; 5,807,956; 5,981,681; 6,207,782; 7,465,439; 7,041,767; 7,217,777; US2007/0286837A1; US2005/0048549A1; US2007/0041929A1; GB849433; DE10036533, which are all incorporated herein by reference; Chemistry and Technology of Silicones, New York: Academic Press (1968); General Electric Silicone Rubber Product Data Sheets SE 30, SE 33, SE 54 and SE 76; Silicon Compounds, Petrarch Systems, Inc. (1984); and in Encyclopedia of Polymer Science and Engineering, vol. 15, 2d ed., pp 204-308, John Wiley & Sons, Inc. (1989).

The compositions of the present invention may also comprise from 0.05 to 3 wt % of at least one organic conditioning oil as the conditioning agent, either alone or in combination with other conditioning agents, such as the silicones (described herein). Suitable conditioning oils include hydrocarbon oils, polyolefins, and fatty esters. Also suitable for use in the compositions herein are the conditioning agents described in U.S. Pat. Nos. 5,674,478 and 5,750,122 or in U.S. Pat. Nos. 4,529,586; 4,507,280; 4,663,158; 4,197,865; 4,217,914; 4,381,919; and 4,422,853.

### Hygiene and Malodour

A composition of the present invention may also comprise one or more of thymol, quaternary ammonium salts such as Bardac® and zinc complexes thereof, silver and silver compounds, especially those designed to slowly release Ag⁺ or nano-silver dispersions.

### Probiotics

A composition may comprise probiotics such as those described in WO09/043709.

### Suds Boosters

If high sudsing is desired, suds boosters such as the C₁₀-C₁₆ alkanolamides or C₁₀-C₁₄ alkyl sulphates can be incorporated into the compositions, typically at 1 to 10 wt % levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous. If desired, water-soluble magnesium and/or calcium salts such as MgCl₂, MgSO₄, CaCl₂), CaSO₄ and the like, can be added at levels of, typically, 0.1 to 2 wt %, to provide additional suds and to enhance grease removal performance.

### Suds Suppressors

Compounds for reducing or suppressing the formation of suds can be incorporated into the compositions of the present invention. Suds suppression can be of particular importance in the so-called “high concentration cleaning process” as described in U.S. Pat. Nos. 4,489,455 and 4,489,574, and in front-loading-style washing machines. A wide variety of materials may be used as suds suppressors, and suds suppressors are well known to those skilled in the art. See e.g. Kirk Othmer Encyclopedia of Chemical Technology, Third Edition, Volume 7, p. 430-447 (John Wiley & Sons, Inc., 1979). Examples of suds supressors include monocarboxylic fatty acid and soluble salts therein, high molecular weight hydrocarbons such as paraffin, fatty acid esters (e.g., fatty acid triglycerides), fatty acid esters of monovalent alcohols, aliphatic C₁₈-C₄₀ ketones (e.g., stearone), N-alkylated amino triazines, waxy hydrocarbons preferably having a melting point below about 100° C., silicone suds suppressors, and secondary alcohols. Suds supressors are described in U.S. Pat. Nos. 2,954,347; 4,265,779; 4,265,779; 3,455,839; 3,933,672; 4,652,392; U.S. Pat. Nos. 4,978,471; 4,983,316; 5,288,431; 4,639,489; 4,749,740; 4,798,679; 4,075,118; EP89307851.9; EP150872; and DOS 2, 124,526.

### Form of the Composition

A composition of the invention is for cleaning or washing, in particular laundry. The composition of the invention may be a liquid detergent composition but may also be a solid or powder detergent composition.

In one aspect the invention relates to a composition, wherein the form of the composition is selected from the group consisting of a regular, compact or concentrated liquid; a gel; a paste; a soap bar; a regular or a compacted powder; a granulated solid; a homogenous or a multilayer tablet with two or more layers (same or different phases); a pouch having one or more compartments; a single or a multi-compartment unit dose form; or any combination thereof.

The form of the composition may separate the components physically from each other in compartments such as, e.g., water dissolvable pouches or in different layers of tablets. Thereby negative storage interaction between components can be avoided. Different dissolution profiles of each of the compartments can also give rise to delayed dissolution of selected components in the wash solution.

Pouches can be configured as single or multicompartments. It can be of any form, shape and material which is suitable for hold the composition, e.g., without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water-soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water-soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids (US2009/0011970 A1).

Water-Soluble Film—The compositions of the present invention may also be encapsulated within a water-soluble film. Preferred film materials are preferably polymeric materials. The film material can e.g. be obtained by casting, blow-moulding, extrusion or blown extrusion of the polymeric material, as known in the art. Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, e.g., a PVA polymer, is at least 60 wt %. The polymer can have any weight average molecular weight, preferably from about 1,000 to 1,000,000, from about 10,000 to 300,000, from about 20,000 to 150,000. Mixtures of polymers can also be used as the pouch material.

Naturally, different film material and/or films of different thickness may be employed in making the compartments of the present invention. A benefit in selecting different films is that the resulting compartments may exhibit different solubility or release characteristics.

Preferred film materials are PVA films known under the MonoSol trade reference M8630, M8900, H8779 and those described in U.S. Pat. Nos. 6,166,117 and 6,787,512 and PVA films of corresponding solubility and deformability characteristics.

The film material herein can also comprise one or more additive ingredients. For example, it can be beneficial to add plasticisers, e.g., glycerol, ethylene glycol, diethyleneglycol, propylene glycol, sorbitol and mixtures thereof. Other additives include functional detergent additives to be delivered to the wash water, e.g., organic polymeric dispersants, etc.

In a preferred embodiment, the parent lipase is a Thermomyces lanuginosus lipase (TLL), e.g., in particular the lipase shown in SEQ ID NO: 1.

It will be understood that for the aforementioned species, the invention encompasses both the perfect and imperfect states, and other taxonomic equivalents, e.g., anamorphs, regardless of the species name by which they are known. Those skilled in the art will readily recognize the identity of appropriate equivalents.

Strains of these species are readily accessible to the public in a number of culture collections, such as the American Type Culture Collection (ATCC), Deutsche Sammlung von Mikroorganismen und Zellkulturen GmbH (DSMZ), Centraalbureau Voor Schimmelcultures (CBS), and Agricultural Research Service Patent Culture Collection, Northern Regional Research Center (NRRL).

The parent lipase may be identified and obtained from other sources including microorganisms isolated from nature (e.g., soil, composts, water, etc.) or DNA samples obtained directly from natural materials (e.g., soil, composts, water, etc.) using the above-mentioned probes. Techniques for isolating microorganisms and DNA directly from natural habitats are well known in the art. A polynucleotide encoding a parent may then be obtained by similarly screening a genomic DNA or cDNA library of another microorganism or mixed DNA sample. Once a polynucleotide encoding a parent has been detected with the probe(s), the polynucleotide can be isolated or cloned by utilizing techniques that are known to those of ordinary skill in the art (see, e.g., Sambrook et al., 1989, supra).

### The Invention is Described in the Following Numbered Paragraphs:

1. A composition comprising:
i) a surfactant or surfactant system;
ii) peptide having the sequence KNLRRIIRKGIHIIKKYF (SEQ ID NO: 1) or a peptide having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1,
iii) a nuclease; and/or
iv) one or more enzyme activities selected from the group of protease (EC 3.4.21.62), alpha-amylase (EC 3.2.1.1), endoglucanase (EC 3.2.1.4), lipase (EC 3.1.1.3), pectate lyase (EC 4.2.2.2), and mannanase (EC 3.2.1.78) activity, or a mixture thereof.
2. The composition of paragraph 1, wherein the nuclease has DNase and/RNase activity.
3. The composition of paragraph 1 or 2, wherein the nuclease is a DNase selected from the group of polypeptides of any one of: SEQ ID NOs: 2, 3, 4, 5, 6, 7, 8, 9, 10, 11, 12, 13, 14, 15, 16, 17, 18, 19, 20, 21, or 22 or a DNase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 2, 3, 4, 5, 6, 7, 8, 9, 10, 11, 12, 13, 14, 15, 16, 17, 18, 19, 20, 21, or 22, respectively.
4. The composition of one one of paragraphs 1-3, wherein the nuclease is the one in SEQ ID NO: 2, SEQ ID NO: 5 or SEQ ID NO: 21, respectively.
5. The composition of any one of paragraphs 1-4, wherein the nuclease is a DNase variant which compared to the polypeptide of SEQ ID NO: 5 further comprises two or more substitutions corresponding to substitutions from the group consisting of N61D, T651, T65V, S82R, K107Q, T127S, T127V, G149N, S164D and L181S, wherein the variant has at least 60%, at leasts 70%, at least 80%, at least 85%, at least 90%, at least 95%, at least 96%, at least 97%, at least 98%, at least 99% but less that 100% sequence identity to SEQ ID NO: 5, and has DNase activity.
6. The composition of paragraph 1-5, wherein the nuclease comprises two, three, four, five substitutions.
7. The composition of any one of paragraphs 3-6, further comprising at least one substitution corresponding to substitutions selected from the group consisting of Q14R, Q14W, K21L, P25S, L33K, Q48D, D561, D56L, S66Y, S68L, Y77T, S102Y, S106A, R109Q, R109T, D116S, D116W, T171W, L181T and L181W (using SEQ ID NO: 5 for numbering).
8. The composition of any one of paragraphs 1-7, wherein the nuclease is a DNase variant comprising a set of substitutions corresponding to the substitutions selected from the group consisting of:
a) G149N together with at least one of the substitutions N61D, T651, T65V, S82R, K107Q, T127S, T127V, S164D and L181S;
b) T651 or T65V together with at least two of the substitutions N61D, S82R, K107Q, T127S, T127V, G149N, S164D and L181S;
c) N61D together with at least two of the substitutions T65I/V, S82R, K107Q, T127S/V, G149N, S164D and L181S, preferably at least two of the substitutions T65I/V, S82R, K107Q, T127S and S164D;
d) S82R together with at least two of the substitutions N61D, T65I, T65V, K107Q, T127S, T127V, G149N, S164D and L181S;
e) K107Q together with at least two of the substitutions N61D, T651, T65V, S82R, T127S, T127V, G149N, S164D and L181S;
f) T127S together with at least two of the substitutions N61D, T651, T65V, S82R, K107Q, G149N, S164D and L181S; and
g) S164D together with at least one of the substitutions N61D, T651, T65V, S82R, K107Q, T127S, T127V, G149N and L181S (using SEQ ID NO: 5 for numbering).
9. The composition of any one of paragraphs 1-8, wherein the nuclease is a DNase variant which compared to the polypeptide in SEQ ID NO: 5 comprises one or more substitutions corresponding to, in partiboth, of the following substitutions: T65V, G149N.
10. The composition of any one of paragraphs 1-9, wherein the DNase is a variant which compared to the polypeptide in SEQ ID NO: 22 comprises one or more substitutions corresponding to the following substitutions: T11, S13Y, T22P, S25P S27L, S39P, S42G, S57W, S59V, V76L, T77Y, Q109R, S116D, S144P, A147H, S167L, G175D and S181L, in particular all of the substitutions.
11. The composition of any one of paragraphs 1-10, wherein the composition provides increased body grime removal when used in a cleaning process, especially in a process of washing laundry comprising body grime, compared to the same composition where:
no peptide according to paragraph 1 (ii), in particular SEQ ID NO: 1, is present; and/or
no nuclease, in particular one according to paragraphs 1 (iii) to paragraph 10, such as SEQ ID NOs: 2, 3, 4, 5, 6, 7, 8, 9, 10, 11, 12, 13, 14, 15, 16, 17, 18, 19, 20, 21, or 22, respectively, in particular SEQ ID NO: 2, SEQ ID NO: 5 or SEQ ID NO: 21, respectively, is present; and/or
no enzyme activities according to paragraph 1 (iv), is (are) present.
12. The composition of any one of paragraphs 1-11, wherein the protease is serine protease, such as a subtilisin, in particular a subtilisin derived from Bacillus lentus or Bacillus clausii.
13. The composition of any one of paragraph 1-12, wherein the alpha-amylase is a bacterial alpha-amylase.
14. The composition of any one of paragraphs 1-13, wherein the endoglucanase is a Cel45 and/or Cel5A endoglucanase, in particular derived from Thielavia terrestis and/or Humicola insolens.
15. The composition of any one of paragraphs 1-14, wherein the lipase is a Thermomyces lanuginosus lipase (TLL) or Geotrichum candidum lipase 1 (GCL1).
16. The composition of any one of paragraphs 1-15, wherein the pectate lyase is a Bacillus subtilis pectate lyase.
17. The composition of any one of paragraphs 1-16, wherein the mannanase is an alkalophilic Bacillus mannanase.
18. The composition of any one of paragraphs 1-17, wherein the composition comprises all of the following enzyme activities: protease (EC 3.4.21.62), alpha-amylase (EC 3.2.1.1), endoglucanase (EC 3.2.1.4), lipase (EC 3.1.1.3), pectate lyase (EC 4.2.2.2), and mannanase (EC 3.2.1.78) activity.
19. The composition of any one of paragraphs 1-18, wherein the composition comprises a surfactant or surfactant system selected from nonionic surfactants, anionic surfactants, cationic surfactants, ampholytic surfactants, zwitterionic surfactants, semi-polar nonionic surfactants, or a mixture thereof.
20. The composition of any one of paragraph 1-19, wherein the composition comprises a surfactant or surfactant system present at a level of from 0.1 to 60 wt %, from 0.2 to 40 wt %, from 0.5 to 30 wt %, from 1 to 50 wt %, from 1 to 40 wt %, from 1 to 30 wt %, from 1 to 20 wt %, from 3 to 10 wt %, from 3 to 5 wt %, from 5 to 40 wt %, from 5 to 30 wt %, from 5 to 15 wt %, from 3 to 20 wt %, from 3 to 10 wt %, from 8 to 12 wt %, from 10 to 12 wt %, from 20 to 25 wt % or from 25-60 wt %.
21. The composition of any one of paragraphs 1-20, wherein the composition comprises a surfactant or surfactant system including a surfactant selected from nonionic surfactants, anionic surfactants, cationic surfactants, ampholytic surfactants, zwitterionic surfactants, semi-polar nonionic surfactants, or a mixture thereof.
22. The composition of any one of paragraphs 1-21, wherein the composition comprises one or more anionic surfactant and/or one or more nonionic surfactant.
23. The composition of any one of paragraphs 1-22, wherein the composition comprises one or more anionic surfactants, preferably linear alkylbenzenesulfonic acid (LAS), alcohol ether sulfate (AEOS) and/or alkyl sulfate (AS), in particular sodium lauryl sulfate (SLS) or sodium laureth sulfate (SLES).
24. The composition of any one of paragraphs 1-23, wherein the composition comprises one or more non-ionic surfactants, preferably alcohol ethoxylate (AEO), in particular linear alcohol (C12-15) ethoxylate.
25. The composition of any one of paragraphs 1-24, wherein the composition comprises one or more anionic surfactants and one or more nonionic surfactants.
26. The composition of any one of paragraphs 1-25, wherein the composition comprises the anionic surfactants linear alkylbenzenesulfonic acid (LAS) and a nonionic surfactant alcohol ethoxylate (AEO).
27. The composition of any one of paragraphs 1-26, wherein the composition comprises a surfactant system comprises LAS, SLES, AS and AEO.
28. The composition of any one of paragraphs 1-27, wherein the composition further comprises one or more components selected from the group of builders, chelating agents, dye transfer inhibiting agents, dispersants, further enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, perfume delivery systems, structure elasticizing agents, fabric softeners, carriers, hydrotropes, processing aids, solvents and/or pigments.
29. The composition of any one of paragraphs 1-28, wherein the composition is formulated as a regular, compact or concentrated liquid; a gel; a paste; a soap bar; a regular or a compacted powder; a granulated solid; a homogenous or a multilayer tablet with two or more layers (same or different phases); a pouch having one or more compartments; a single or a multi-compartment unit dose form; or any combination thereof.
30. A method for cleaning or washing of laundry comprising contacting the laundry comprising body grime with a composition of any one of paragraphs 1-29.
31. The method of paragraph 30, wherein the laundry comprising body grime includes textiles, clothes, linen or the like, wherein the laundry may be made from any material including yarns, yarn intermediates, fibers, non-woven materials, natural materials, synthetic materials, and any other textile material, fabrics made of these materials and products made from fabrics (e.g., garments and other articles).
32. The method of paragraph 30 or 31, wherein the laundry comprising body grime is in the form of knits, wovens, denims, non-wovens, felts, yarns, and towelling.
33. The method of any one of paragraph 30-32, wherein the laundry comprising body grime is cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof, or wherein the laundry is non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers, in particular wherein the blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell).
34. The method of any one of paragraphs 30-33, wherein the peptide is dosed at a concentration of 0.001-100 ppm, in particular 0.01-50 ppm.
35. Use of a composition according to any one of paragraphs 1-29 for removing body grime on laundry.
36. The use of a composition according to any one of paragraphs 1-29 for increasing body grime removal from laundry compared to the same composition where:
no peptide according to paragraph 1 (ii), in particular SEQ ID NO: 1 is present; and/or
no nuclease, in particular the one in paragraphs 1 (iii) to paragraph 10, such as SEQ ID NOs: 2, 3, 4, 5, 6, 7, 8, 9, 10, 11, 12, 13, 14, 15, 16, 17, 18, 19, 20, 21, or 22, respectively, in particular SEQ ID NO: 2, SEQ ID NO: 5 or SEQ ID NO: 21, is preset; and/or
no enzyme activities according to paragraph 1 (iv), is (are) present.

The present invention is further described by the following examples that should not be construed as limiting the scope of the invention.

### Materials & Methods

### Materials:

Peptide 1 is the alkaline peptide disclosed in SEQ ID NO: 1.
Nuclease 1: DNase derived from Aspergillus orzyae shown in SEQ ID NO: 2.
Enzyme Blend (EB) consisting of:
Protease: Protease (EC 3.4.21.62)-substlisin variant
Alpha-amylase (EC 3.2.1.1)-bacterial alpha-amylase variant
Endoglucanase (EC 3.2.1.4)-endoglucanase derived from Thielavia terrestis
Endoglucanase (EC 3.2.1.4)-endoglucanase derived from Humicola insolens
Lipase (EC 3.1.1.3)-Thermomyces lanugigosus lipase variant
Pectate lyase (EC 4.2.2.2)-pectate lyase variant derived from Bacillus subtilis
Mannanase (EC 3.2.1.78)-mannanase from alkalophilic Bacillus

### Enzyme Activity:

Enzyme activities can be measured using well known art recognized standard methods.

### Model Detergent 1

| Composition of Model Detergent 1 | Active content |
|---|---|
| Sodium linear alkylbenzene sulfonate | 12.0% |
| (Na-LAS) | |
| Sodium lauryl ether sulfate (SLES) | 4.1% |
| Alcohol ethoxylate with 7 mol EO (AEO) | 12.0% |
| Topped Palm Kernel Fatty Acid | 3.0% |
| Sodium hydroxide | 0.5% |
| Ethanol | 6.0% |
| Propylene glycol (MPG) | 2.0% |
| Triethanolamine (TEA) | 2.0% |
| Trisodium citrate dihydrate | 3.9% |
| Diethylenetriaminepentakis(methylene) | 1.6% |
| pentakis(phosphonic acid), heptasodium | |
| salt (DTPMP Na7) | |
| 2-Phenoxyethanol | 0.5% |
| Water (demineralized) | Ad 100% |
| pH target 8.2-8.6 | 8.4 |

### Methods

Assay I: Testing of DNase activity.

DNase activity may be determined on DNase Test Agar with Methyl Green (BD, Franklin Lakes, NJ, USA), which is prepared according to the supplier's manual. Briefly, 21 g of agar is dissolved in 500 ml water and then autoclaved for 15 min at 121° C. Autoclaved agar is adjusted to 48° C. in a water bath, and 20 ml of agar is poured into petri dishes and allowed to solidify by incubation overnight at room temperature. On solidified agar plates, 5 μl of enzyme solutions are added and DNase activity is observed as colorless zones around the spotted enzyme solutions.

### Construction of Variants by Site-Directed Mutagenesis

Site-directed variants are constructed by traditional cloning of DNA fragments (Sambrook et al., Molecular Cloning: A Laboratory Manual, 2nd Ed., Cold Spring Harbor, 1989) using PCR together with properly designed mutagenic oligonucleotides that introduced the desired mutations in the resulting sequence.

Mutagenic oligos are designed corresponding to the DNA sequence flanking the desired site(s) of mutation, separated the by the DNA base pairs defining insertions/deletions/substitutions, and purchased from an oligo vendor such as Life Technologies. In order to test the variants, the mutated DNA encoding a variant is integrated into a competent A. oryzae strain by homologous recombination, fermented using standard protocols (yeast extract based media, 3-4 days, 30° C.), and purified by chromatography.

### EXAMPLES

Unless explicitly stated otherwise, all percentages given are percentages by weight (weight %, % by wt. or wt.-%).

### Example 1

### Preparation of Sebum/DNA Mixture (Imitated Body Grime (IBG) Soiling)

1. Preparation of Bey-Sebum-granulated Pig Skin proteins-Environmental dust solution: Sebum solution: Fat phase: 7.5 g Sebum Bey (Center for Testmaterials BV, P.O. Box 120, 3133 KT Vlaardingen, (CFT), Netherlands) and 1.125 g of VE-fat (CFT, Netherlands) were melted at 75° C. and poured into aquous phase: 142.5 g deionized water and 1.69 g MF-fat (CFT, Netherlands), while mixing using an ultra-Turrax at a speed setting of 3-5.

Dust solution: Fat phase: 20 g Sebum Bey (CFT, Netherlands) and 1.5 g of VE-fat (CFT, Netherlands) were melted at 75° C. and poured into aquous phase: 180 g deionized water and 2.5 g MF-fat (CFT, Netherlands) and 40 g Test Dust (KSL11046; KSL Staubtechnik, Konrad Schuhmacher, Lauingen, Germany), while mixing using an ultra-Turrax at a speed setting of 3-5. Salmon testes DNA (0.383 g, CAS no. 438545-06-3) was added to the sebum solution. The mixture was stirred on a magnet stirrer for 1 hour at 400 rpm (rpm: resolution per minute), at 50° C., until completely dissolved. Once the dust solution cools to 50° C., 4.88 g finely granulated pig skin proteins (Air bag pore farina, i.e., granulated and dried pig skin, Sosa ingredients, Cataluna, Spain—freeze dried and ground into fine powder) was mixed well into the sample and incubated at room temperature for 1 hour. The dust solution was poured through a 4-layer gauze cloth and the material on the gauze was transferred to filter paper to remove excess water. The dust protein paste was combined in a 1:1 ratio by weight with the sebum solution and stirred well. Stored at 4° C. overnight to thicken.

### Example 2

### Preparing IBG Stain Swatches (Imitated Body Grime Swatches)

Material was warmed to 35-40° C. and applied to pre-washed CN-42 (CFT) cut in 5×5 cm pieces. An amount of 0.29-0.30 g per stain was applied and rubbed in using a finger in a circular motion. All stains were then subjected to 2 bar pressure in a Mathis-machine (Mathis AG).

Sebum/DNA mixture (200 μL) from Example 1 was also applied to knitted polyester, WFK 33A (6 cm×6 cm). The stains were left to dry overnight in the dark at room temperature before being used.

### Example 3

### Alkaline Peptide 1's (SEQ ID NO: 1) Effect on IBG Stain Removal During Wash

30 mL wash liquid (deionized water, Model Detergent 1) 3.33 g/L detergent and water hardness ions giving 15° dH at the ratio of 4:1:7.5 (Ca;Mg:HCO₃),) was added to 50 mL Nalgene bottles with each 10 metal beads. Each bottle also contained two 2 cm-diameter circular IBG stains (containing IBG soiling on cotton swatches) prepared as per example 1 and other standard commercial soils that have been cut into 4 pieces each (C—H152 and C—H156 from CFT, Netherlands).

Peptide1, Nuclease 1, and the Enzyme Blend (EB) were added to bottles according to Table 1 below. Wash was started by closing the bottle lids and placing closed bottles within Wascator FOM71 CLS (Electrolux) which used 25 L water to move around the closed bottles during the wash time at 25° C. wash temperature.

After 30 minutes wash, the swatches were removed from each bottle, rinsed in a container under running tap water and added to a European Miele Frontloader W1935 WTL full scale wash machine to be centrifugated according to the centrifugation program.

After washing and rinsing the swatches were spread out flat and allowed to air dry at room temperature overnight. Light reflectance evaluations of the swatches were done using a Datacolor 800v reflectance spectrophotometer with large aperture. Delta remission values for individual swatches were calculated by subtracting the remission value at 460 nm of the control swatch from the remission value at 460 nm of the washed swatch. Calculating the enzyme effect was done by taking the measurements from washed swatches with enzymes and subtract with the measurements from washed without enzyme for each stain. The total enzyme performance was calculated as the average of individual ΔRem.

Wash performance is expressed as a delta remission measured value (ΔRem).

TABLE 1

| | | | Delta |
|---|---|---|---|
| | | | Remission |
| | | Remission | units 460 nm |
| | | units 460 nm | (blank |
| Detergent | Added components | after wash | subtracted) |
| Model | Blank | 33.3 | 0 |
| Detergent 1 | Enzyme Blend (1.04%) | 33.8 | 0.5 |
| | Enzyme Blend (1.04%) + | 38.2 | 5.0 |
| | Nuclease 1 (0.2%) | | |
| | Peptide 1 (2.5 ppm) | 32.2 | 0 |
| | Enzyme Blend (1.04%) + | 37.1 | 3.8 |
| | Peptide 1 (2.5 ppm) | | |
| | Enzyme Blend - 1.04% + | 39.8 | 6.5 |
| | Nuclease 1 (0.2%) + | | |
| | Peptide 1 (2.5 ppm) | | |

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

1. A composition comprising:
i) a surfactant or surfactant system;
ii) peptide having the sequence KNLRRIIRKGIHIIKKYF (SEQ ID NO: 1) or a peptide having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 1,
iii) a nuclease; and/or
iv) one or more enzymes selected from the group of protease (EC 3.4.21.62), alpha-amylase (EC 3.2.1.1), endoglucanase (EC 3.2.1.4), lipase (EC 3.1.1.3), pectate lyase (EC 4.2.2.2), and mannanase (EC 3.2.1.78), or a mixture thereof.

2. The composition of claim 1, wherein the nuclease has DNase and/or RNase activity.

3. The composition of claim 1, wherein the nuclease is a DNase selected from the group of polypeptides of any one of: SEQ ID NOs: 2, 3, 4, 5, 6, 7, 8, 9, 10, 11, 12, 13, 14, 15, 16, 17, 18, 19, 20, 21, or 22 or a DNase having at least 60%, at least 65%, at least 70%, at least 75%, at least 80%, at least 85%, at least 90%, at least 95% identity, at least 96%, at least 97%, at least 98%, or at least 99%, or 100% sequence identity to SEQ ID NO: 2, 3, 4, 5, 6, 7, 8, 9, 10, 11, 12, 13, 14, 15, 16, 17, 18, 19, 20, 21, or 22, respectively.

4. The composition of claim 1, wherein the nuclease has the amino acid sequence of SEQ ID NO: 2, SEQ ID NO: 5 or SEQ ID NO: 21.

5. The composition of claim 1, wherein the protease is a serine protease, the alpha-amylase is a bacterial alpha-amylase; the endoglucanase is a Cel45 and/or Cel5A endoglucanase, the lipase is a Thermomyces lanuginosus lipase (TLL) or Geotrichum candidum lipase 1 (GCL1); the pectate lyase is a Bacillus subtilis pectate lyase; and the mannanase is an alkalophilic Bacillus mannanase.

6. The composition of claim 1, wherein the composition comprises all of the following enzyme activities: protease (EC 3.4.21.62), alpha-amylase (EC 3.2.1.1), endoglucanase (EC 3.2.1.4), lipase (EC 3.1.1.3), pectate lyase (EC 4.2.2.2), and mannanase (EC 3.2.1.78) activity.

7. The composition of claim 1, wherein the composition comprises a surfactant or surfactant system selected from nonionic surfactants, anionic surfactants, cationic surfactants, ampholytic surfactants, zwitterionic surfactants, semi-polar nonionic surfactants, or a mixture thereof.

8. A method for cleaning or washing of laundry comprising contacting the laundry comprising body grime with a composition of claim 1.

9. (canceled)

10. The method of claim 8, wherein body grime removal from laundry is increased compared to an otherwise identical composition where:
no peptide according to claim 1 part ii) is present; and/or
no nuclease according to claim 1 part iii) to claim 4, is present; and/or
no enzyme activities according to claim 1 part iv), is(are) present.

11. The composition of claim 1, wherein the peptide has at least 90% sequence identity to the amino acid sequence of SEQ ID NO: 1.

12. The composition of claim 1, wherein the nuclease is a DNase with at least 90% sequence identity to SEQ ID NO: 2, 3, 4, 5, 6, 7, 8, 9, 10, 11, 12, 13, 14, 15, 16, 17, 18, 19, 20, 21, or 22.

13. The composition of claim 1, wherein the one or more enzyme of part iv) is a protease, wherein the protease is a subtilisin.

14. The composition of claim 1, wherein the one or more enzyme of part iv) is a protease, wherein the protease is a subtilisin derived from Bacillus lentus or Bacillus clausii.

15. The method of claim 8, wherein the peptide has at least 90% sequence identity to the amino acid sequence of SEQ ID NO: 1.

16. The method of claim 8, wherein the nuclease is a DNase with at least 90% sequence identity to SEQ ID NO: 2, 3, 4, 5, 6, 7, 8, 9, 10, 11, 12, 13, 14, 15, 16, 17, 18, 19, 20, 21, or 22.

17. The method of claim 8, wherein the one or more enzyme of claim 1 part iv) is a protease, wherein the protease is a subtilisin.

18. The method of claim 8, wherein the one or more enzyme of claim 1 part iv) is a protease, wherein the protease is a subtilisin derived from Bacillus lentus or Bacillus clausii.


SEQUENCE LISTING (22 sequences)

SEQ ID NO: 1 - protein, 18 aa, synthetic construct
KNLRRIIRKGIHIIKKYF

SEQ ID NO: 2 - protein, 221 aa, Aspergillus oryzae
VPVNPEPDATSVENVALKTGSGDSQSDPIKADLEVKGQSALPFDVDCWAILCKGAPNVLQRVNEKTKNSNRDRSGANKGPFKDPQKWGIKALPPKNPSWSAQDFKSPEEYAFASSLQGGTNAILAPVNLASQNSQGGVLNGFYSANKVAQFDPSKPQQTKGTWFQITKFTGAAGPYCKALGSNDKSVCDKNKNIAGDWGFDPAKWAYQYDEKNNKFNYVGK

SEQ ID NO: 3 - protein, 206 aa, Aspergillus oryzae
ALKTGSGDSQSDPIKADLEVKGQSALPFDVDCWAILCKGAPNVLQRVNEKTKNSNRDRSGANKGPFKDPQKWGIKALPPKNPSWSAQDFKSPEEYAFASSLQGGTNAILAPVNLASQNSQGGVLNGFYSANKVAQFDPSKPQQTKGTWFQITKFTGAAGPYCKALGSNDKSVCDKNKNIAGDWGFDPAKWAYQYDEKNNKFNYVGK

SEQ ID NO: 4 - protein, 204 aa, Aspergillus oryzae
KTGSGDSQSDPIKADLEVKGQSALPFDVDCWAILCKGAPNVLQRVNEKTKNSNRDRSGANKGPFKDPQKWGIKALPPKNPSWSAQDFKSPEEYAFASSLQGGTNAILAPVNLASQNSQGGVLNGFYSANKVAQFDPSKPQQTKGTWFQITKFTGAAGPYCKALGSNDKSVCDKNKNIAGDWGFDPAKWAYQYDEKNNKFNYVGK

SEQ ID NO: 5 - protein, 182 aa, synthetic construct
IPPGTPSKSAAQYQLNALTVKPEGPMLGYSRDLFPHWIPQGGGCDTRQVVLKRDADWYVGNCPVTSGSWYSYYDGLYFTNPSDLDIDHIVPLAEAWRSGASSWTTSKRRDFANDLDGPQLIAVSASTNRSKGDQDPSTWQPPRPGAHCGYSKWWISTKYKWGLSLQLSEKTALQDMLNSCLY

SEQ ID NO: 6 - protein, 182 aa, Metabacillus indicus [sequence omitted]

SEQ ID NO: 7 - protein, 182 aa, synthetic construct
IPPGTPSKSAAQYQLNALTVKPEGSMLGYSRDKFPHWIPQGGGCDTRQVVLKRDAIWYVGNCPVVSGSWYSYYDGLTFTNPSDLDIDHIVPLAEAWRSGASSWTTSKRRDFANDLDGPQLIAVSASVNRSKGDQDPSTWQPPRPGAHCGYSKWWISTKYKWGLSLQLSEKTALQDMLNSCSY

SEQ ID NO: 8 - protein, 186 aa, Trichoderma reesei
APLPAPPGIPSEDTARTQLAGLTVAVVGSGTGYSRDLFPTWDAISGNCNAREYVLKRDGEGVQVNNACEAQSGSWISPYDNASFTNASSLDIDHMVPLKNAWISGASTWTTAQREALANDVSRPQLWAVSASSNRSKGDRSPDQWKPPLTSFYCTYAKSWIDVKSYYKLTITSAEKTALSSMLDTC

SEQ ID NO: 9 - protein, 219 aa, Tolypocladium inflatum
APFPEPAPSLEAESWTDDAIQPGIPSASTARTLLAGLQVAASGSGTGYSREKFPHWATISGTCNARYDPSRGTVSRQLTLACRSEFVLKRDGENVVVNSACTAESGTWKSPYDGASWTQASDIDIDHMVPLKNAWISGASSWTTDQRKGFANDITRPQLWAVTDNVNQAKSDSSPDRWKPPLTSFYCTYAKSWVQVKSYYKLTVTDAEKGALSGMLDSC

SEQ ID NO: 10 - protein, 190 aa, Blastomyces gilchristii
STIPLHKRDPPNIPSPPEASRLLELMVVSPQGPQTGYSRTKFPHWITINGPCNTRETVLKRDGMNVTVGKNCSPKSGSWYSTYDGVTLTSSSNVDIDHVVPLSDAWKSGASGWTRERRRDFANDMENPQLISVQGKVNKEKGDKGPDKWKPPLPTYHCTYACMWVKVKSAYNLTITDPEKQALMDMLGTC

SEQ ID NO: 11 - protein, 188 aa, Gelasinospora tetrasperma
APAPMPTPPGIPTAANAKTQLASLTVKAYVDDGKYERDLFPTWITISGTCNTREYVLKRDGTNVVTDSACTATSGTWASPYDGGVWTAASDVDIDHMVPLKNAWVSGANAWTTSKRQQFANDINSPQLWAVTDNVNQAKSDQSPDAWKPPLTSFYCTYAKAWVQVKYTWALTITSAEKSALTSMLNTC

SEQ ID NO: 12 - protein, 292 aa, Streptococcus dysgalactiae
KTVSVNQTYGEYKDYYTVIGESNIDQSAFPKIYKTTERVYKGQGTSEKRVTVSDVVYNPLDGYKRSTGAYGVVTKDMIDMSKGYREKWETNPEPSGWFRFYNRADNEEISEKEYDSRRTKSYKVTNNVPVVLTTLKGKKYNSHLFVASHLFADSLGGKSIRKNAITGTQMQNVGTRKGGMQYIEKKVLSHITKNPDVYVFYSAIPEYQGAELLARSVLVSALSSDGVINETVRVFNTADGFNINYEKGGLLTESPVSEIDNIEDSTTDEIENSVDDSEEIVYNDTTTEEEEN

SEQ ID NO: 13 - protein, 209 aa, Thermobifida cellulosilytica
LDDLLAELEEIEADVPATAESQAPEGDADAVEARQRLGEIPIAEPAPRGDYDRDEFGSGWIDTDGNGCSTRNDILARDLENVQLASDGCKVLSGTLHDPYTGATIEFTSEKPQAVQIDHVVPLSLAWRMGASRWDRDTRVEFANDPGNLLASDGPANREKSDSGPGEWQPYEGFQCTYAVLYIDVLYRYDLPVSEQDYEGLSAMLDTCA

SEQ ID NO: 14 - protein, 267 aa, Rasamsonia composticola
WGNLGHETIAYIAQNFVASSTASYCQDVLGDTSSSYLASVATWADSYRYTSAGRWSEPLHFIDAHDDPPTSCGVDYERDCGDKGCVVSAINNYTTQLLDKSTSSSEALDAMKFIIHFVGDIHQPLHDENLDVGGNDIDVTFNGTKTNLHHIWDTNMLEADAGGSSLSTAKSFAATLTTRLQSGEYASQKASWISGMNISDPVATAMGWASDANGYVCSTVLKPGLSYIKDNDLSGKYYADCKPVFEELLARAGYRLAAWLDLIAKQQ

SEQ ID NO: 15 - protein, 190 aa, Chaetosartorya cremea
IPVPVALPTPPGIPSAATAESELAALTVAAQGSSSGYSRDLFPHWITQSGTCNTREVVLARDGSNIVRDSSCYPTSGSWYSPYDGATWTQASDVDIDHVVPLSNAWKSGASKWTTPQRQAFANDLTNPQLMAVTDNVNQAKGDSGPEDWKPPLTSYYCTYAKMWVRVKYVYDLTITSAEKSALVSMLDRC

SEQ ID NO: 16 - protein, 182 aa, Aspergillus bisporus
TPPGIPSTSSAKSQLAALTVRSAGSSSGYSRDLFPHWINQGNNCNTREVVLARDGSNVQTGSDCAPTSGSWYSPYDGATWYQASDVDIDHVVPLSNAWKSGASSWTTSRRQAFANDLSNPQLIAVTDNVNQSKGDKGPEEWKPPRTAYHCTYAKMWVRVKYVYGLTVTSSEKSALSSMLNTC

SEQ ID NO: 17 - protein, 184 aa, Aspergillus clavatus
LPTPPGIPSAATAESELASLTVAPQGSEDGYSRELFPHWINQGNHCNTRDMVLARDGQDVVQDDDCYPTSGTWYSPYDGTTWTEAKKLDIDHFVPLANAWRSGASEWSTAQRTAFANDLTHPQLVAVSEKANRSKGDKGPEEWKPPLASFHCTYARMWVSVKSTYALTITSEEKEALVSMLDTC

SEQ ID NO: 18 - protein, 147 aa, Metarhizium acridum
VPIPEPTPSGIWTSPYDGLVFTEAHKLDIDHFVPLKNAWMVRKNQGPFPAGIVRIFAWLTCRLQSGASEWTDEQREAFANDLARPQLWAVSAHANRQKGDKGPDGWKPPLTSFFCTYAESWVEVKGYYNLTISESEKEALGSMLDDC

SEQ ID NO: 19 - protein, 182 aa, Aspergillus ochraceoroseus
TPPGIPSTSSAKSQLSSLTVAAQGSQSGYSRDLFPHWIDQGNSCNTREDVLIRDGTGVTTGSACKITAGSWYSPYDGATWTAASDVDIDHVVPLSNAWKSGASSWTTEERTAFANDLENPQLMAVTDNVNQAKGDKGPEDWQPPLSSYHCTYAKMWVRVKSVYDLTITSKEKSALQDMLATC

SEQ ID NO: 20 - protein, 182 aa, Bacillus cibi; identical to SEQ ID NO: 5

SEQ ID NO: 21 - protein, 182 aa, synthetic construct
IPPGTPSKSAAQYQLNALTVKPEGPMLGYSRDLFPHWIPQGGGCDTRQVVLKRDADWYVGNCPVVSGSWYSYYDGLYFTNPSDLDIDHIVPLAEAWRSGASSWTTSKRRDFANDLDGPQLIAVSASTNRSKGDQDPSTWQPPRPGAHCNYSKWWISTKYKWGLSLQLSEKTALQDMLNSCLY

SEQ ID NO: 22 - protein, 182 aa, Bacillus cibi [sequence omitted]